(19) United States
(12) Patent Application Publication
(10) Pub. No.: US 2025/0103372 A1
(43) Pub. Date: Mar. 27, 2025

(54) KEY HIERARCHIES FOR VIRTUAL TRUSTED PLATFORM MODULES IN COMPUTING SYSTEMS

(71) Applicant: Microsoft Technology Licensing, LLC, Redmond, WA (US)

(72) Inventors: Pushkar Vijay CHITNIS, Bothell, WA (US); Ahmad ABDULLATEEF, Duvall, WA (US); David Kimler ALTOBELLI, Redmond, WA (US); Sergio Shingchow WONG, Redmond, WA (US)

(21) Appl. No.: 18/474,131

(22) Filed: Sep. 25, 2023

(51) Int. Cl. G06F 9/455

(52) U.S. Cl. CPC G06F 9/45558; G06F 2009/4557; G06F 2009/45587

(57) ABSTRACT

Systems, methods, devices, and computer readable storage media described herein provide techniques utilizing key hierarchies for virtual trusted platform modules (vTPMs). In an aspect, a system comprises a vTPM. The vTPM receives a first seed value representative of a system feature of the system. The vTPM generates the first key from the first seed value, the first key configured to unseal a sealed state of an operating system of a virtual machine. The vTPM utilizes the first key to unseal the sealed state. The vTPM provides the unsealed state to an instance of the virtual machine to cause the instance to boot the operating system based on the unsealed state. In a further aspect, the vTPM receives, from an application executed by the instance, a request to perform a cryptographic operation to modify an object utilizing the first key.

### BACKGROUND

Computing devices can be used to host instances of virtual machines. For instance, a host computing device may host a “guest” virtual machine instance. The host computing device and the guest virtual machine instance may or may not be managed by different entities (e.g., different users and/or organizations). The entity associated with the guest virtual machine may set various policies that restrict the type of device that may host the guest virtual machine. When the virtual machine instance is installed on the host computing device, secrets and/or keys associated with the virtual machine instance (e.g., the entity's secrets and/or keys) may be exposed to the host computing device and/or other services executing thereon.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments are described herein for providing virtual trusted platform modules (vTPMs) that perform security functions according to key hierarchies. In an aspect, a vTPM is executing on a computing device of a system. The computing device is configured to host an instance of a virtual machine. The vTPM receives a first seed value representative of a system feature of the system. The vTPM generates the first key from the first seed value, the first key configured to unseal a sealed state of an operating system of the virtual machine. The vTPM utilizes the first key to unseal the sealed state. The vTPM provides the unsealed state to an instance of the virtual machine to cause the instance to boot the operating system based on the unsealed state.

In a further aspect, the vTPM receives a second seed value representative of another system feature. The vTPM generates the first key from the first seed value and the second seed value.

In a further aspect, the vTPM is rebooted. Subsequent to the vTPM being rebooted, the vTPM receives a second seed value representative of the system feature. The vTPM determines whether the second seed value meets criterion for unsealing the sealed state of the operating system. If so, the vTPM unseals the sealed state of the operating system. Otherwise, the vTPM fails to unseal the sealed state of the operating system.

In a further aspect, the vTPM receives, from an application executed by the instance, a request to perform a cryptographic operation to modify an object utilizing the first key.

In a further aspect, the vTPM determines a cryptographic operation is to be performed. The vTPM determines whether a lifetime of a key configured for use in performing the cryptographic operation has expired. If the lifetime of the key has not expired, the vTPM attempts to perform the cryptographic operation. If the lifetime of the key has expired, performance of the cryptographic operation fails.

In an alternative aspect, a vTPM is executing on a computing device of a system. The computing device is configured to host an instance of a virtual machine. The vTPM receives a first key corresponding to a system feature of the system. The first key is configured to unseal a sealed state of an operating system of the virtual machine. The vTPM utilizes the first key to unseal the sealed state. The vTPM provides the unsealed state to an instance of the virtual machine to cause the instance to boot the operating system based on the unsealed state.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a block diagram of a system for providing a vTPM that performs security functions according to key hierarchies, in accordance with an embodiment.

FIG. 2 shows a block diagram of host computing device configured to host a virtual machine comprising a virtual trusted platform module (TPM), in accordance with an embodiment.

FIG. 3 shows a flowchart of a process for enabling the booting of an operating system based on a sealed state of the operating system, in accordance with an embodiment.

FIG. 4A shows a flowchart of a process for receiving a seed value representative of a system feature, in accordance with an embodiment.

FIG. 4B shows a flowchart of another process for receiving a seed value representative of a system feature, in accordance with another embodiment.

FIG. 4C shows a flowchart of another process for receiving a seed value representative of a system feature, in accordance with another embodiment.

FIG. 4D shows a flowchart of another process for receiving a seed value representative of a system feature, in accordance with another embodiment.

FIG. 5 shows a flowchart of a process for generating a key, in accordance with an embodiment.

FIG. 6 shows a flowchart of a process for determining whether to unseal a sealed state of an operating system, in accordance with an embodiment.

FIG. 7 shows a block diagram of a system comprising a rebooted vTPM, in accordance with an embodiment.

FIG. 8 shows a flowchart of a process for determining whether a key is able to unseal a sealed state of an operating system, in accordance with an embodiment.

FIG. 9 shows a block diagram of a system for performing a cryptographic operation, in accordance with an embodiment.

FIG. 10 shows a flowchart of a process for performing a cryptographic operation, in accordance with an embodiment.

FIG. 11 shows a flowchart of a process for determining whether a lifetime of a key has expired, in accordance with an embodiment.

FIG. 12 shows a flowchart of a process for determining whether a key is to be refreshed, in accordance with an embodiment.

FIG. 13 shows a flowchart of a process for utilizing a received key to unseal a sealed state of an operating system, in accordance with an embodiment.

FIG. 14 shows a flowchart of a process for performing a cryptographic operation, in accordance with an embodiment.

FIG. 15 shows a block diagram of an example computing system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### II. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Embodiments for Key Hierarchies in Virtual Trusted Platform Modules

Computing devices can be used to host instances of virtual machines. For instance, a host computing device in an implementation can be configured to host one or more “guest” virtual machine instances (also referred to as “VM instances” herein). The host computing device executes a virtual machine manager configured to (e.g., utilizing a hypervisor) create, manage, and/or otherwise support the VM instances. The virtual machine manager can interact directly with the hardware components of the host computing device. Alternatively, the virtual machine manager is hosted by a host operating system deployed to interact with the hardware components of the host computing device.

In implementations of host computing devices, the VM instance and the host computing device may be managed by (or owned by or used by or otherwise associated with) different entities. For instance, as a non-limiting example, a host computing device is managed by a service provider (e.g., a cloud service provider, an enterprise service provider, etc.) that provides resources (e.g., host computing devices and/or other hardware and associated software or firmware) to a customer entity. In this example, the VM instance is associated with another entity (e.g., a user entity (e.g., a customer of the service provider, a family user, a group of users, etc.), an organization entity (e.g., a customer organization of the service provider, a tenant of the service provider, a group of organizations, etc.), a computing service (e.g., an application or service acting on behalf of another entity), and/or another type of entity, as would be understood by a person ordinarily skilled in the relevant art(s) having benefit of this disclosure.

In some implementations, such as in confidential computing applications, the entity associated with the VM instance desires the VM instance to be deployed by a host computing device that satisfies certain policies. Embodiments described herein provide techniques for evaluating the system a VM instance is to be deployed in (also referred to as the “destination system” herein) and determining whether or not the destination system satisfies required policies. In particular, embodiments utilize a virtual trusted platform module (vTPM) to evaluate the destination system. The vTPM provides a tamper-resistant platform for performing security functions. To perform these security functions, the vTPM derives a key from features of the destination system, referred to herein as “system features.” Examples of such system features include, but are not limited to: hardware configurations of the system (e.g., a particular hardware component of the host computing device (e.g., a processor (e.g., a central processing unit, a graphics processing unit, a co-processor, etc.), a memory (e.g., a volatile memory device, a non-volatile memory device, etc.), a peripheral device (e.g., an input device, an output device, a storage device, etc.), a hardware TPM, and/or any other hardware component of the host computing device), an identifier that uniquely identifies a hardware component of the host computing device, a combination of hardware components, and/or any other configuration of hardware associated with the system), a geographic region (e.g., a particular datacenter or other facility the system is located in, a city, a county, a state, a province, a country, and/or the like, and/or a group of geographic regions) the host computing system is located in and/or assigned to, a tenant of a cloud service to which the vTPM is assigned to, the VM instance (e.g., an identifier that uniquely identifies the VM instance), a feature of the virtual machine (e.g., an operating system of the virtual machine (e.g., an identifier that uniquely identifies the version or instance of the operating system, a version of the operating system, a type of the operating system, etc.), a firmware disk of the virtual machine (e.g., a version of the firmware disk, an identifier that uniquely identifies the firmware disk, etc.), a geographic region the virtual machine is assigned to, etc.), and/or any other feature of the system to which the VM instance is to be deployed and/or a component or sub-service thereof.

Embodiments described herein provide and/or utilize a vTPM that provides entities flexibility in determining a “security domain” to which their keys and/or secrets are bound to. A “security domain” is a type or particular instance of a system a virtual machine is to be deployed to, a subset of such a system, and/or an environment such a system is locating and/or operating in. In embodiments, a vTPM may perform cryptographic operations to bind an object to a security domain and/or based on the security domain the object is (e.g., already) bound to. Examples of objects to be bound to or to be modified by cryptographic operations include, but are not limited to, a state of an operating system of a virtual machine, a firmware state of the virtual machine, a cryptographic key (e.g., a cryptographic key generated by the vTPM or a cryptographic key otherwise protected by (e.g., encrypted by) a security function of the vTPM), data (e.g., data to be encrypted), encrypted versions of data, applications, and/or the like.

As noted above, vTPMs may bind objects to security domains and/or perform cryptographic operations with respect to objects based on the security domain the object is bound to. In accordance with an embodiment, one or more system features may be used to bind an object to a security domain. Examples of security domains include, but are not limited to, a hardware security domain (i.e., a security domain determined based on hardware-binding system features (e.g., hardware configurations and/or any other system feature (or combination of system features) that may be used to bind an object to hardware), a geographic domain (i.e., a security domain determined based on geographic-binding system features (e.g., a geographic region a host computing device is located in and/or assigned to, a geographic region a VM instance is assigned to, geographic region a vTPM is assigned to, and/or any other system feature (or combination of system features) that may be used to bind an object to a geographic region)), a service provider domain (i.e., a security domain based on service-provider-binding system features (e.g., a service-provider-defined region (e.g., an availability zone of a service platform, a data center of the service provider, all (e.g., global) of the service platform, etc.), a tenant a vTPM and/or VM instance is assigned to, and/or any other system feature (or combination of system features) that may be used to bind an object based on configurations of a service provider)), a VM instance domain (i.e., a security domain determined based on VM-instance-binding system features (e.g., the VM instance, a feature of the virtual machine, and/or any other system feature (or combination of system features) that may be used to bind an object to a VM instance)), and a virtual machine disk domain (“VM disk domain” herein) (i.e., a security domain determined based on VM-disk-binding system features (e.g., a firmware disk of the virtual machine, an operating system disk of the virtual machine, a version of the operating system of the virtual machine, a version of the firmware of the virtual machine, and/or any other system feature (or combination of system features) that may be used to bind an object to a particular operating system and/or firmware disk)).

The techniques described herein provide custom key hierarchies that provide entities flexibility in determining the security domain (or security domains) in which objects are bound to by a vTPM. For example, in an aspect, embodiments described herein include a system comprising a processor and memory comprising program code executable by the processor, the program code comprising a VM instance and a vTPM. The vTPM receives a first seed value representative of a system feature of the system. The vTPM generates a first key from the first seed value, the first key configured to unseal a sealed state of an operating system of the virtual machine. The vTPM utilizes the first key to unseal the sealed state of the operating system. The vTPM provides the unsealed state to the VM instance to cause the VM instance to boot the operating system based on the unsealed state. In this manner, embodiments described herein mitigate or prevent access to a virtual machine's operating system (which may enable access to an entity's secrets) on an unauthorized hardware, in an unauthorized region, in an unauthorized VM instance, by a tampered version of a VM instance, and/or in an otherwise unauthorized system.

Furthermore, in another (e.g., further or alternative) aspect, embodiments described herein include a system comprising a processor and memory comprising program code executable by the processor, the program code comprising a VM instance and a vTPM. The VM instance executes an application. The vTPM receives, from the application, a request to perform a cryptographic operation to modify an object (e.g., seal, unseal, sign, verify, encrypt, decrypt, and/or any other modification by a cryptographic operation described herein and/or as would be understood by a person skilled in the relevant art(s) having benefit of this disclosure) by utilizing a key (e.g., the same key used to unseal the sealed state of the operating system, another key generated by vTPM, another key obtained by the vTPM, and/or the like). The vTPM utilizes the key to perform the requested cryptographic operation to modify the object. In this manner, embodiments described herein mitigate or prevent access to objects (which may include an entity's secrets or enable access to an entity's secrets) on an unauthorized hardware, in an unauthorized region, in an unauthorized VM instance, by a tampered version of a VM instance, and/or in an otherwise unauthorized system.

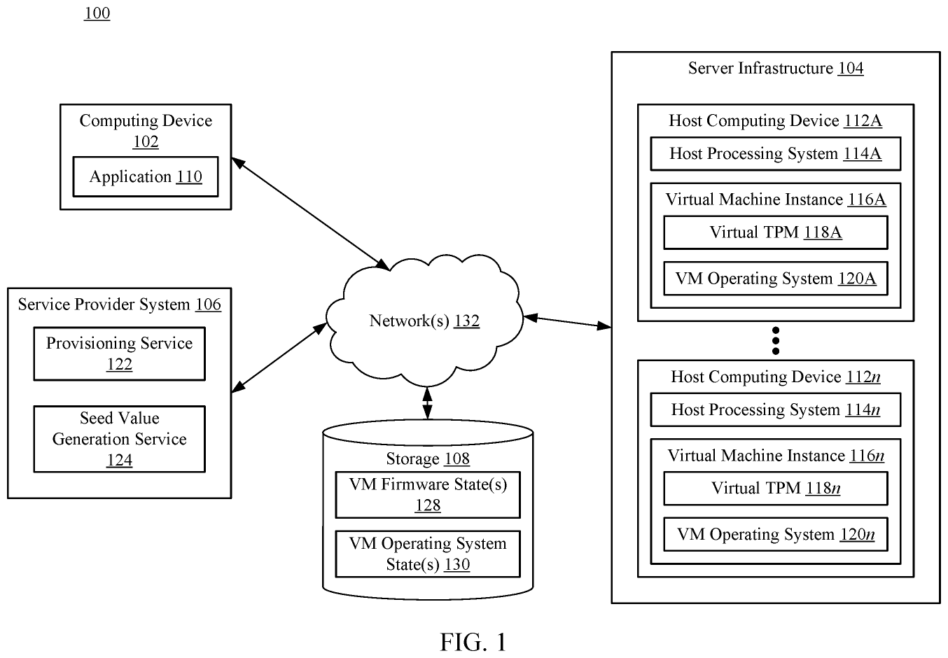

To help illustrate the aforementioned embodiments, FIG. 1 will now be described. In particular, FIG. 1 shows a block diagram of a system 100 for providing a vTPM that performs security functions according to key hierarchies, in accordance with an embodiment. As shown in FIG. 1, system 100 includes a computing device 102, a server infrastructure 104, a service provider system 106, and storage 108. Each of computing device 102, server infrastructure 104, service provider system 106, and storage 108 are communicatively coupled via a network 132. Network 132 may comprise one or more networks such as local area networks (LANs), wide area networks (WANs), enterprise networks, the Internet, etc., and may include one or more of wired and/or wireless portions.

Storage 108 stores one or more virtual machine firmware states 128 (referred to as “VM firmware states 128” herein) and one or more virtual machine operating system states 130 (referred to as “VM operating system states 130” herein). In embodiments, any of the states of VM firmware states 128 and/or VM operating states 130 may be stored as sealed states, as described elsewhere herein. In accordance with an embodiment, storage 108 stores (e.g., sealed or unsealed) states of applications executable by virtual machine instances hosted by host computing devices of server infrastructure 104, as described elsewhere herein. As shown in FIG. 1, storage 108 is external to computing device 102, server infrastructure 104, and service provider system 106; however, it is also contemplated that all or a portion of storage 108 may be internal to computing device 102, a computing device of server infrastructure 104, and/or a computing device of service provider system 106. In accordance with an embodiment, storage 108 is a remote storage accessible over network 132 (e.g., a web storage, a blob storage, a networked file system, a cloud storage, and/or the like)

Computing device 102 may be any type of stationary or mobile processing device, including, but not limited to, a desktop computer, a server, a mobile or handheld device (e.g., a tablet, a personal data assistant (PDA), a smart phone, a laptop, etc.), an Internet-of-Things (IoT) device, etc. In accordance with an embodiment, computing device 102 is associated with a user (e.g., an individual user, a group of users, an organization, a family user, a customer user, an employee user, an admin user (e.g., a service team user, a developer user, a management user, etc.), etc.). Computing device 102 may access host computing devices of server infrastructure 104 and/or applications executed by the host computing devices, as described elsewhere herein. Computing device 102 stores data and executes computer programs, applications, and/or services. For instance, as shown in FIG. 1, computing device 102 executes an application 110. In accordance with an embodiment, and as described elsewhere herein, application 110 enables a user to access and/or utilize virtual machines (e.g., VM instances) hosted by server infrastructure 104.

Server infrastructure 104 may be a network-accessible server set (e.g., a cloud-based environment, an enterprise network server set, and/or the like). As shown in FIG. 1, server infrastructure 104 comprises host computing devices 112A-112n. In some embodiments, host computing devices 112A-112n form a cluster of host computing devices. Alternatively, subsets of host computing devices 112A-112n form separate clusters. In another alternative or additional embodiment, host computing devices 112A-112n includes one or more independent host computing devices. Each of host computing devices 112A-112n may be any type of stationary or mobile processing device of server infrastructure 104 (e.g., a server or another type of computing device, as described elsewhere herein). In accordance with an embodiment, each of host computing devices 112A-112n comprises a host processing system and is configured to execute an instance of a virtual machine (a “VM instance”). For example, as shown in FIG. 1, host computing device 112A comprises a host processing system 114A and is configured to execute a virtual machine instance 116A (“VM instance 116A” herein) and host computing device 112n comprises a host processing system 114n and is configured to execute a virtual machine instance 116n (“VM instance 116n” herein). In accordance with an embodiment, the VM instance is stored in memory of the respective host computing device as program code executable by the respective host processing system. In accordance with an embodiment, VM instance 116A and/or VM instance 116n are confidential virtual machines (“CVMs”). In accordance with an embodiment, a user of computing device 102 (or application 110 on behalf of the user) accesses host computing device 112A and/or host computing device 112n to utilize VM instance 116A and/or VM instance 116n.

As noted above, a user or application may access host computing devices 112A-112n to utilize respective VM instances 116A-116n. Each of VM instances 116A-116n comprises a vTPM and a virtual machine operating system (also referred to as a “VM operating system” or “guest operating system”). For example, as shown in FIG. 1, VM instance 116A comprises a vTPM 118A and a VM operating system 120A and VM instance 116n comprises a vTPM 118n and a VM operating system 120n. Each of VM operating systems 120A-120 are configured to execute applications (not shown in FIG. 1 for brevity). While FIG. 1 illustrates only one VM instance on each of host computing devices 112A-112n, it is further contemplated herein that a host computing device may host any number of VM instances. Furthermore, not all VM instances need be associated with the same entity and/or user account.

As shown in FIG. 1, each of vTPMs 118A-118n are guest vTPMs of the respective VM instance. In an alternative embodiment, any of vTPMs 118A-118n may be implemented as a stand-alone vTPM executing as an independent application or as an application separate from the respective VM instance of VM instances 116A-116n. Each of vTPMs 118A-118n provides a tamper-resistant platform for performing security functions on behalf of a respective VM instance of VM instances 116A-116n. An example of a security function includes, but is not limited to, performing a cryptographic operation to modify an object. In an example embodiment, the object is associated with the respective VM instance, an application executed by the respective VM instance, and/or an operation the VM instance (or an application executed thereby or another component or subservice of the VM instance) is attempting to perform. Examples of a cryptographic operation include, but are not limited to, sealing an object, unsealing an object, signing an object, decrypting an object, and/or encrypting an object.

Furthermore, and as described elsewhere herein, vTPMs 118A-118n are configured to generate keys configured to be utilized in attempts to perform cryptographic operations (e.g., to unseal and/or seal objects (e.g., to unseal or seal states of operating systems of virtual machines, to unseal or seal states of applications, etc.), to encrypt and/or decrypt objects, to sign or verify objects, and/or to perform any other cryptographic operation described herein). In accordance with an embodiment, each of vTPMs 118A-118n is configured to generate such a key from one or more seed values. The seed values are representative of a respective system feature of the system the respective VM instance is deployed to (e.g., a respective system comprising the respective host computing device of host computing devices 112A-112n). For instance, each of vTPMs 118A-118n may be configured to generate a key from seed values representative of a hardware configuration of the system, a geographic region the host computing device is located in and/or assigned to, a tenant of a service to which the respective VM instance and/or vTPM is assigned to, the respective VM instance and/or a feature thereof, and/or any other feature of the system to which the VM is to be deployed (or is in the process of being deployed to) and/or a component or subservice thereof. In accordance with an embodiment, the same key may be used for multiple cryptographic operations (e.g., the same key (e.g., a decryption key) is used for unsealing and/or decrypting objects, the same key (e.g., an encryption key) is used for sealing and/or encrypting objects, etc.). In an alternative embodiment, separate keys are used for each cryptographic operation (e.g., a first decryption key is used for unscaling objects and a second decryption key is used for decrypting objects, a first encryption key is used for sealing objects and a second encryption key is used for encrypting objects, a signing key is used for signing objects, a verification key is used for verifying objects, and/or the like). Moreover, different keys may be used to perform a type of cryptographic operation with respect to a particular object (e.g., a first decryption key is used for unsealing an operating state of a virtual machine, a second decryption key is used for unsealing a state of a (e.g., particular) application, etc.).

Service provider system 106 may be any type of stationary or mobile processing device (e.g., a server or another type of computing device, as described elsewhere herein) associated with a service provider. As shown in FIG. 1, service provider system 106 executes a provisioning service 122 and a seed value generation service 124. Provisioning service 122 and/or seed value generation service 124 may execute on the same computing device and/or different computing devices. Alternatively, provisioning service 122 and/or seed value generation service 124 (or subservices thereof) may be incorporated as a service executing on a computing device (e.g., a host computing device or other computing device (not shown in FIG. 1)) of server infrastructure 104. As shown in FIG. 1, provisioning service 122 and seed value generation service 124 are incorporated in the same system (i.e., service provider system 106). Alternatively, provisioning service 122 and/or seed value generation service 124 may be incorporated in a different system (e.g., a different system of the service provider, a system of a third party (e.g., a third party seed value generation service), and/or the like).

Provisioning service 122 is configured to generate VM firmware states, vTPM states and/or VM operating system states, encrypt the generated states, and/or orchestrate key rotation workflows for virtual machines. For instance, provisioning service 122 is configured to generate a VM firmware state and store it in storage 108 as VM firmware states 128. In accordance with an embodiment, the generated VM firmware state comprises a vTPM. For instance, in this example embodiment, the VM firmware state corresponding to VM instance 116A comprises vTPM 118A and the VM firmware state corresponding to VM instance 116n comprises vTPM 118n. Alternatively, provisioning service 122 generates and stores a firmware state for the vTPM separate from the VM firmware state (e.g., in an implementation where the vTPM executes as a service external to the virtual machine). Furthermore, provisioning service 122 is configured to generate VM operating system states and store them in storage 108 as VM operating system states 130. In accordance with an alternative embodiment, provisioning service 122 generates and stores one or more of a VM firmware state, a vTPM state, and/or a VM operating state as a single state in storage 108.

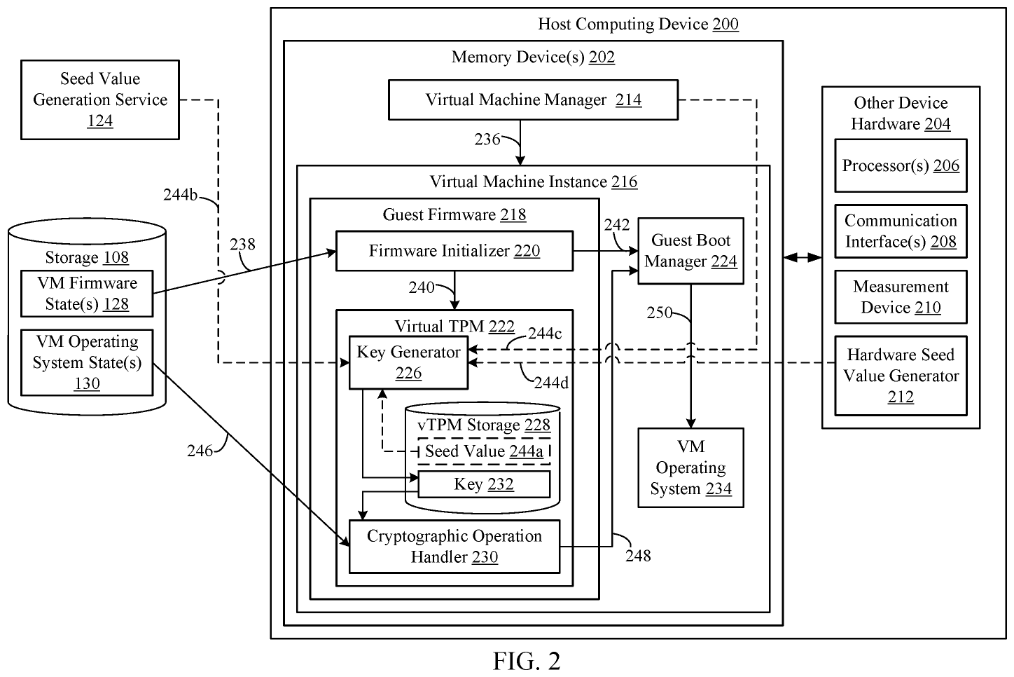

Seed value generation service 124 is configured to generate seed values. In particular, seed value generation service 124 is configured to generate seed values representative of system features associated with service provider system 106, a VM instance, and/or other information managed by or on behalf of a service provider of service provider system 106. For instance, seed value generation service 124 may generate seed values representative of system features such as, but not limited to, a tenant to which a vTPM is assigned to, the tenant to which a virtual machine is assigned to, a geographic region to which a virtual machine is assigned to, a geographic region to which a vTPM is assigned to, an identifier that uniquely identifies a VM instance, a firmware disk of a virtual machine, an operating system of a virtual machine, an identifier of the service provider and/or of service provider system 106, and/or any other feature of the system to which a VM instance is to be deployed (or is in the process of being deployed to) wherein seed value generation service 124 may generate a corresponding seed value thereof. In accordance with an embodiment, provisioning service 122 is configured to include seed values generated by seed value generation service 124 (e.g., by including the seed value in a state of guest firmware, by including the seed value in a state of a vTPM, and/or otherwise storing seed values in storage). Alternatively, seed value generation service 124 provides generated seed values to a vTPM executing on a host computing device (e.g., vTPM 118A executing on host computing device 112A, vTPM 118n executing on host computing device 112n, and/or the like). Additional details regarding seed value generation service 124 providing generated seed values to a vTPM are described with respect to FIGS. 2, 3, and 4D, as well as elsewhere herein. Moreover, seed values may be generated by other components and/or subcomponents of system 100 (e.g., components and/or subcomponents of host computing devices 112A-112n), as described further with respect to FIGS. 2, 3, 4B, and 4C as well as elsewhere herein.

In embodiments, vTPMs 118A-118n are configured to verify whether or not the corresponding host computing device satisfies certain policies to host respective VM instances 116A-116n. For instance, an entity associated with a VM instance of VM instances 116A-116n may set one or more policies that restrict which systems are allowed to host the respective VM instance. By doing so, the entity restricts which systems may have access to secrets (e.g., private keys, private data, and/or other sensitive information) associated with the VM instance. In embodiments, the entity (e.g., a user (e.g., the user of computing device 102, a group of users, a family user, etc.), an account associated with the user, an application executing on behalf of the user (e.g., application 110), an organization (e.g., the user's employer, a service provider (e.g., of service provider system 106), etc.), a developer of the virtual machine, and/or another type of entity that desires restricting which system may host a VM instance) sets a policy to restrict which systems may host a VM instance based on system features of the system. Each of vTPMs 118A-118n is configured to verify whether or not the system features of respective systems (e.g., host computing devices 112A-112n) satisfy the policy. If the vTPM determines the respective system satisfies the policy (e.g., by succeeding in unsealing an operating system state of the virtual machine), the vTPM enables the operating system of the VM instance to boot. Otherwise, the operating system of the VM instance does not boot (or does not complete booting), thereby preventing unauthorized access to a booted version of the operating system.

As a non-limiting example, suppose a user of computing device 102 utilizes an interface of computing device 102 to interact with application 110 to request host computing device 112A to host VM instance 116A. In this example, further suppose deployment of VM instance 116A is restricted based on a policy of a managing entity (i.e., an “Entity Policy”). In this example, host processing system 114A executes a process to create VM instance 116A. For instance, host processing system 114A may receive a firmware state of VM instance 116A (e.g., by receiving the firmware state included in the request from computing device 102, by requesting computing device 102 to provide the firmware state, by accessing storage 108 to obtain the firmware state (e.g., stored as VM firmware state(s) 128), and/or the like). Host processing system 114A installs the firmware based on the received firmware state. In accordance with an embodiment, the installed version of the firmware comprises vTPM 118A. Alternatively, host processing system 114A executes a process to install vTPM 118A separate from the process to install the firmware state. Additional details regarding the installation of VM firmware and vTPMs are described with respect to FIG. 2, as well as elsewhere herein.

With continued reference to the non-limiting example, vTPM 118A is configured to verify whether or not the system VM instance 116A is deploying to satisfies the Entity Policy that applies to VM instance 116A. In accordance with an embodiment, and in this non-limiting example, vTPM 118A verifies whether or not the system satisfies the Entity Policy prior to booting VM operating system 120A. For instance, vTPM 118A is configured to determine whether or not the system satisfies the Entity Policy and, if so, unseal a sealed state of VM operating system 120A. In accordance with an embodiment, vTPM 118 is configured to determine whether or not the system satisfies the Entity Policy by attempting to unseal the sealed state of VM operating system 120A utilizing a (e.g., decryption) key. If successful, VM instance 116A (or a subservice thereof) utilizes the unsealed state to boot VM operating system 120A. If not successful, vTPM 118A fails to unseal the sealed state and VM operating system 120A is not booted. Additional details regarding unsealing a sealed state of an operating system are described with respect to FIGS. 2, 3, and 6-14. By determining whether the system satisfies the Entity Policy prior to booting VM operating system 120A, vTPM 118A prevents access to an unsealed version of the operating system state (which may enable access to secrets) in an unauthorized system (e.g., on unauthorized hardware, in an unauthorized region, in an unauthorized VM instance, at an unauthorized time, and/or otherwise in a system with a feature that does not satisfy a criterion of the Entity Policy).

Host computing devices may be configured to host VM instances and vTPMs may be configured to perform security functions in various ways, in embodiments. For instance, FIG. 2 shows a block diagram of host computing device 200 configured to host a virtual machine comprising a virtual trusted platform module (TPM), in accordance with an embodiment. FIG. 2 also depicts seed value generation service 124 and storage 108, as described with respect to FIG. 1. As shown in FIG. 2, host computing device 200 comprises one or more memory device(s) 202 (“memory 202” herein) and other device hardware 204 (“hardware 204” herein).

Memory 202 includes volatile storage portions such as random access memory (RAM) and/or persistent storage portions such as hard drives, non-volatile RAM, and/or the like, to store or to be configured to store computer program instructions/code. As shown in FIG. 2, memory 202 comprises a virtual machine manager 214 and a virtual machine instance 216 (“VM instance 216”). VM instance 216 is an example of VM instances 116A-116n, as described with respect to FIG. 1.

Hardware 204 comprises device hardware of host computing device 200 in addition to memory 202. For instance, as shown in FIG. 2, hardware 204 comprises one or more processors 206 (“processor 206” herein), one or more communication interfaces 208 (“communication interfaces 208” herein), a measurement device 210, and a hardware seed value generator 212. In embodiments, hardware 204 may include additional hardware not shown in FIG. 2 for illustrative clarity and brevity (e.g., peripheral devices, hardware TPMs, and/or any other hardware component of a host computing device). Processor 206 is an example of host processing systems 114A-114n as described with respect to FIG. 1. Processor 206 comprises circuitry configured to execute computer instructions such as, but not limited to, embodiments of virtual machine manager 214 and VM instance 216, including one or more sub-components or subservices thereof, which may be implemented as computer program instructions, as described herein.

Communication interfaces 208 includes any type or number of wired and/or wireless communication or network adapters, modems, etc., configured to enable host computing device 200 to communicate intra-system with components thereof, as well as with other devices and/or systems over a network, such as communications between host computing device 200 and other devices or systems, as described with respect to system 100 in FIG. 1 (e.g., over network 132). For instance, communication interfaces 208 in accordance with an embodiment enables host computing device 200 to communicate with seed value generation service 124 and storage 108, as shown in FIG. 2, and described elsewhere herein.

Measurement device 210 is configured to measure other hardware of host computing device 200 and/or firmware and/or software stored by memory 202. In accordance with an embodiment, measurement device 210 measures memory 202 and generates a report. The report comprises measurements of the memory and/or any other attributes of host computing device 200. In accordance with an embodiment measurement device 210 comprises a hardware-based TPM. In accordance with an embodiment, measurement device 210 utilizes a hashing algorithm to generate a hash-chained measurements log representative of hardware measurements taken by measurement device 210.

Hardware seed value generator 212 is configured to generate seed values representative of system features of hardware (e.g., memory 202 and/or hardware 204) of host computing device 200. For instance, hardware seed value generator 212 may generate seed values representative of system features such as, but not limited to, a hardware configuration of host computing device 200 (e.g., a configuration of memory 202, processor 206, an interface of communication interfaces 208, measurement device 210, hardware seed generator 212, and/or other hardware of computing device 200 not shown in FIG. 2 for brevity, and/or configurations of any combination of hardware of host computing device 200), a geographic region host computing device 200 is located in and/or assigned to, firmware and/or software stored in memory 202, a measurement by measurement device 210, a hashed measurement generated by measurement device 210, an intermediate hash generated by measurement device 210, a hash-chained measurements log generated by measurement device 210, and/or any other feature of the system to which a VM instance is to be deployed (or is in the process of being deployed to) wherein hardware seed value generator 212 may generate a corresponding seed value thereof.

As noted above, memory 202 stores virtual machine manager 214 and VM instance 216. Hypervisor 214 is configured to create, manage, and/or otherwise support the VM instances. As shown in FIG. 2, virtual machine manager 214 interacts directly with hardware 204 of host computing device 202. In an alternative embodiment, memory 202 stores a host operating system that interacts with hardware 204 and hosts virtual machine manager 214 (e.g., as a subservice of the host operating system).

VM instance 216 is an instance of a virtual machine hosted by host computing device 200. In accordance with an embodiment VM instance 216 is a confidential virtual machine. As shown in FIG. 2, VM instance 216 comprises a guest firmware 218, a guest boot manager 224, and a virtual machine operating system 234 (“VM operating system 234” herein), each of which may be subservices of VM instance 216. VM operating system 234 is an example embodiment of VM operating systems 120A-120n as described with respect to system 100 of FIG. 1. In accordance with an embodiment, guest firmware 218 is a host compatibility layer of VM instance 216. As further shown in FIG. 2, guest firmware 218 comprises a firmware initializer 220 and a vTPM 222. In accordance with an embodiment, firmware initializer 220 comprises guest boot manager 224. The vTPM 222 is an example embodiment of vTPMs 118A-118n as described with respect to system 100 of FIG. 1. As shown in FIG. 2, vTPM 222 comprises a key generator 226, vTPM storage 228 (“vTPM storage 228” herein), and a cryptographic operation handler 230. Key generator 226 and cryptographic operation handler 230 are sub-services of vTPM 222. In accordance with an embodiment, vTPM storage 228 represents a secure portion of memory 202 accessible to vTPM 222 (e.g., and not accessible to other services executing on host computing device 200). In this context, access to data stored in vTPM storage 228 is prevented except by vTPM 222.

As noted above, virtual machine manager 214 creates, manages, and supports virtual machines hosted by host computing device 200. For instance, virtual machine manager 214 creates and manages VM instance 216. In accordance with an embodiment, virtual machine manager 214 utilizes a hypervisor (not shown in FIG. 2 for brevity) to create, manage, and/or otherwise support VM instance 216. As shown in FIG. 2, virtual machine manager 214 launches VM instance 216 via launch operation 236. In accordance with an embodiment, virtual machine manager 214 executes launch operation in response to a request received from an entity (e.g., a user (e.g., a user of computing device 102 of FIG. 1), an organization, an application executing on behalf of a user or organization (e.g., application 110), etc.), a computing device associated with an entity (e.g., computing device 102), and/or the like. To create VM instance 216, virtual machine manager 214 may obtain VM firmware (e.g., VM firmware included in the request to launch the virtual machine, one of VM firmware states 128 stored in storage 108, and/or the like) and launch operation 236 includes initializing the firmware. Alternatively, and as shown in FIG. 2, launch operation 236 initially installs firmware initializer 220. Firmware initializer 220 receives VM firmware state 238 from VM firmware states 128 stored in storage 108. VM firmware state 238 corresponds to the virtual machine requested to launch.

In some embodiments, VM firmware state 238 is a sealed firmware state. In this context, measurement device 210 (or a hardware-based TPM of measurement device 210) or processor 206 determines whether or not to unseal VM firmware state 238 and/or otherwise attempts to unseal VM firmware state 238. If the VM firmware state 238 is unsealed, firmware initializer 220 installs vTPM 222 via TPM launch operation 240 and loads guest boot manager 224 via boot manager launch operation 224.

In accordance with an embodiment, VM firmware state 238 includes a state of vTPM 222. Alternatively, the state of vTPM 222 is stored as a separate state in storage 108 (not shown in FIG. 2 for brevity). In an embodiment, TPM launch operation 240 includes the state of vTPM 222. Alternatively, TPM launch operation 240 causes vTPM 222 to obtain the state of vTPM 222 from storage 108 (e.g., as part of the launching/booting process of vTPM 222).

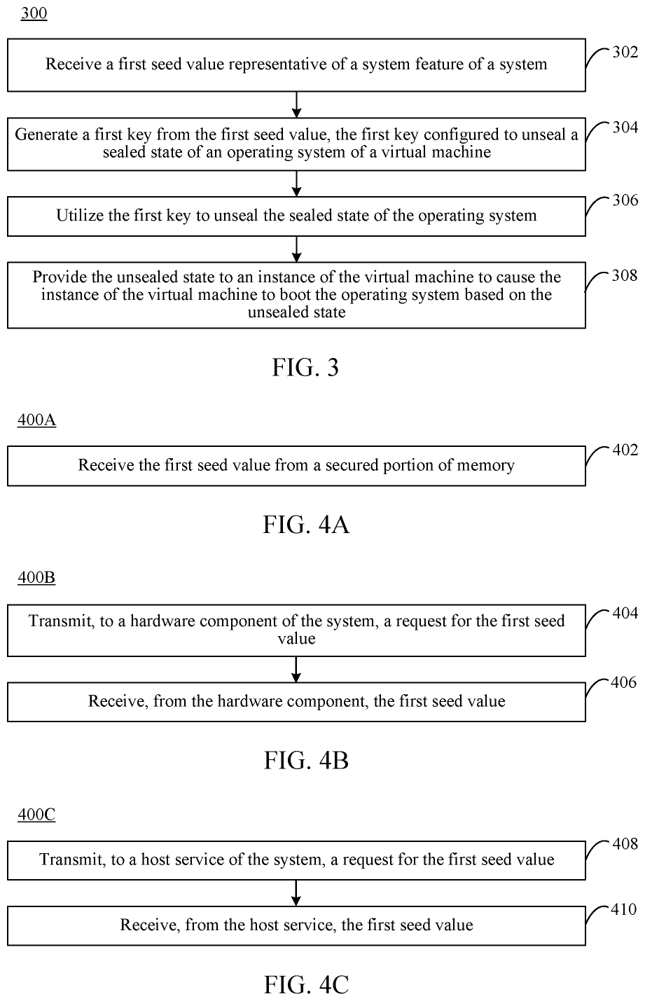

In embodiments, vTPM 222 is configured to provide a tamper-resistant platform for performing security functions. In accordance with an embodiment, vTPM 222 is configured to determine whether or not to unseal an operating system state of VM instance 216 and, if so, enable guest boot manager 224 to boot VM operating system 234. To better illustrate embodiments of enabling booting a virtual machine operating system based on a sealed state of the operating system, host computing device 200 is further described with respect to FIG. 3. FIG. 3 shows a flowchart 300 of a process for enabling booting an operating system based on a sealed state of the operating system, in accordance with an embodiment. In an embodiment, vTPM 222 may operate according to flowchart 300. Note that not all steps of flowchart 300 need be performed in all embodiments. Further structural and operational embodiments will be apparent to persons skilled in the relevant art(s) based on the following descriptions of FIGS. 2 and 3.

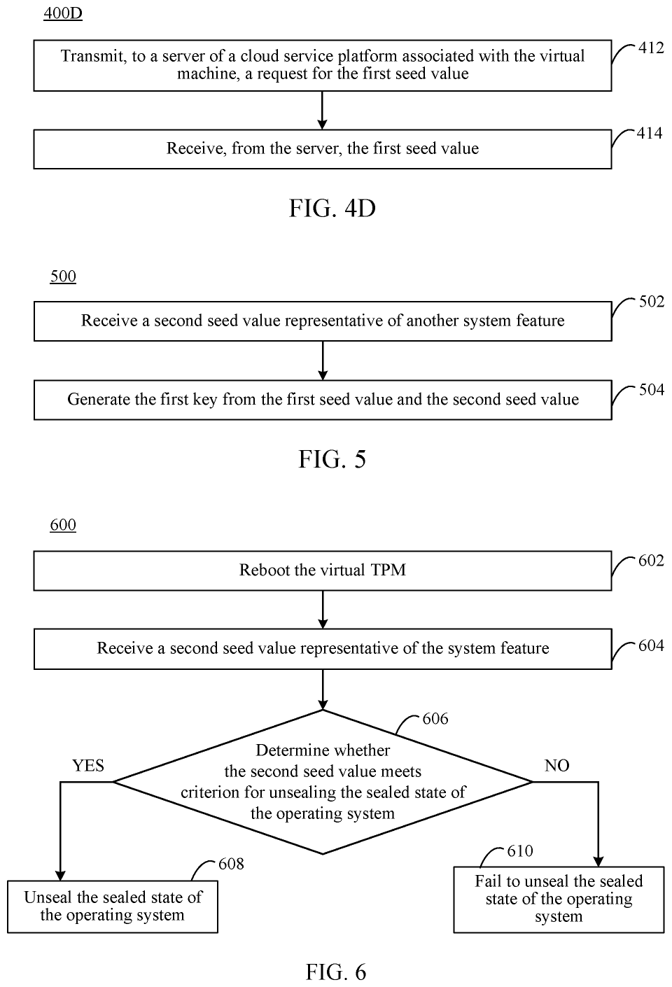

Flowchart 300 begins with step 302. In step 302, a first seed value representative of a system feature of a system is received. For example, key generator 226 of vTPM 222 of FIG. 2 receives a first seed value representative of a system feature of the system comprising host computing device 200. As shown in FIG. 2, key generator 226 may receive a seed value 244A from vTPM storage 228, a seed value 244b from seed value generation service 124, a seed value 244c from virtual machine manager 214, and/or a seed value 244d from hardware seed value generator 212. In accordance with an embodiment, vTPM 222 receives the seed value subsequent to installation on (or booting on) host computing device 200 (i.e., after being launched by TPM launch operation 240) and prior to booting VM operating system 234. In accordance with another embodiment, vTPM 222 receives the seed value in (or in response to) a request to perform a cryptographic operation. In accordance with an embodiment, and as described with respect to FIG. 4A, vTPM 222 (or a secure portion of memory accessible to vTPM 222) is preconfigured with the seed value. In accordance with an embodiment, and as described further with respect to FIGS. 4B-4D, vTPM 222 receives the seed value by requesting a corresponding service and/or device to provide the seed value to vTPM 222. In accordance with an embodiment, and as described further with respect to FIG. 5, multiple seed values are received. In accordance with an embodiment, vTPM 222 stores the received seed value in storage accessible to vTPM 222 (e.g., vTPM storage 228).

In accordance with an embodiment, key generator 226 receives a particular seed value based on a configuration of vTPM 222. For instance, the service that configured vTPM 222 (e.g., during the generation of VM firmware state 238 or during the generation of firmware for vTPM 222) (e.g., provisioning service 122) in accordance with an embodiment configured vTPM 222 to require one or more seed values representative of respective system features to perform security functions. In this context, the service may determine which seed values are required based on a policy that applies to the virtual machine vTPM 222 corresponds to. For instance, the seed values required by vTPM 222 may be determined based on a security or access policy of a user or other entity associated with the virtual machine. By configuring a vTPM to require seed values representative of particular system features, embodiments described herein provide an entity flexibility in terms of which features of a system must satisfy a criterion of the entity's policy in order to host a virtual machine.

In step 304, a first key is generated from the first seed value, the first key is configured to unseal a sealed state of an operating system of a virtual machine. For example, key generator 226 of FIG. 2 generates a key 232 from the seed value(s) received in step 302 (e.g., seed value 244a, seed value 244b, seed value 244c, and/or seed value 244d). In accordance with an embodiment, key generator 226 generates key 232 from the seed value(s) received in step 302 using a mathematical formula (e.g., multiplication, addition, etc.). In accordance with an embodiment, key 232 is a master wrapping key of vTPM 222 (also referred to as a storage root key). In accordance with an embodiment, key 232 is a private-public key pair comprising a first private key (e.g., configured for use in unscaling, decrypting, and/or signing operations) and a first public key (e.g., configured for use in sealing, encrypting, and/or signature verification operations). In accordance with an embodiment, the first private key is an endorsement key of vTPM 222. By generating a master wrapping key from seed values received from services and/or components of a system and/or coupled to the system to which the VM instance is to be (or in the process of being) deployed to, vTPM 222 provides flexibility in restricting which type of systems may host a particular VM instance.

In step 306, the first key is utilized to unseal the sealed state of an operating system. For example, cryptographic operation handler 230 of FIG. 2 utilizes key 232 to unseal a sealed state 246 of VM operating system 234. As shown in FIG. 2, cryptographic operation handler 230 receives sealed state 246 by accessing VM operating states 130 stored by storage 108. Alternatively, sealed state 246 is included in VM firmware state 238. In accordance with another alternative embodiment, sealed state 246 is included in the request to launch VM instance 216 (e.g., received by virtual machine manager 214 prior to the process of flowchart 300). If cryptographic operation handler 230 is successfully able to unseal sealed state 246, flowchart 300 continues to step 308. In this context, the successful unsealing of sealed state 246 indicates the system features of the system comprising host computing device 200 satisfy criteria of a policy that restricts the system VM instance 216 may be deployed to. In other words, the seed values received in step 302 and representative of the system features generate the correct key (e.g., key 232) for unsealing sealed state 246. As a non-limiting example, suppose sealed state 246 was generated by another vTPM sealing the state of a corresponding VM operating system using a public cryptographic key of a key pair. In this example, key 232 is a private cryptographic key of the key pair. Additional details regarding unsealing a sealed state, as well as failing or denying unscaling a sealed state, are described with respect to FIGS. 6-8, as well as elsewhere herein.

In step 308, the unsealed state is provided to the instance of the virtual machine to cause the instance of the virtual machine to boot the operating system based on the unsealed state. For example, cryptographic operation handler 230 of FIG. 2 provides unsealed state 248 to guest boot manager 224 of VM instance 216 to cause guest boot manager 224 to boot VM operating system 234 based on unsealed state 248. By preventing booting VM operating system 234 until the operating state is unsealed in this way, vTPM 222 improves computer security by reducing or preventing access to unsealed state 248 (which may enable access to an entity's secrets) on unauthorized hardware, in an unauthorized region, in an unauthorized VM instance, and/or in an otherwise unauthorized system.

Key generator 226 may receive seed values in various ways, in embodiments. For example, FIG. 4A shows a flowchart 400A of a process for receiving a seed value representative of a system feature, in accordance with an embodiment. Flowchart 400A is a further embodiment of step 302 of flowchart 300, as described with respect to FIG. 3. Key generator 226 of FIG. 2 may operate according to flowchart 400A in embodiments. Note that flowchart 400A need not be performed in all embodiments. Further structural and operational embodiments will be apparent to persons skilled in the relevant art(s) based on the following descriptions of FIG. 4A with respect to FIG. 2.

Flowchart 400A includes step 402. In step 402, the first seed value is received from a secured portion of memory. For example, key generator 226 of FIG. 2 receives seed value 244a from vTPM storage 228. In accordance with an embodiment, seed value 244a is a seed value previously received by key generator 226 and stored in vTPM storage 228. In accordance with another embodiment, seed value 244a is a preconfigured seed value of vTPM 222. For instance, provisioning service 122 of FIG. 1 may include seed value 244a (e.g., generated by seed value generation service 124) in VM firmware state 238 or firmware of vTPM 222.

Flowchart 400A of FIG. 4A is described with respect to key generator 226 receiving seed value 244a from vTPM storage 228; however, it is also contemplated herein that key generator 226 may be configured to receive seed value 244a from other secure portions of memory 202 (or other memory devices not shown in FIG. 2) accessible to vTPM 222. For instance, vTPM storage 228 in accordance with an embodiment receives seed value 244a from memory external to VM instance 216.

As noted above, key generator 226 may receive seed values in various ways, in embodiments. FIG. 4B shows a flowchart 400B of another process for receiving a seed value representative of a system feature, in accordance with another embodiment. Flowchart 400B is a further embodiment of step 302 of flowchart 300, as described with respect to FIG. 3. Key generator 226 of FIG. 2 may operate according to flowchart 400B in embodiments. Note that not all steps of flowchart 400B need be performed in all embodiments. Further structural and operational embodiments will be apparent to persons skilled in the relevant art(s) based on the following descriptions of FIG. 4B with respect to FIG. 2.

Flowchart 400B begins with 404. In step 404, a request for the first seed value is transmitted to a hardware component of the system. For example, key generator 226 of FIG. 2 transmits a request (not shown in FIG. 2) to hardware seed value generator 212 (e.g., via virtual machine manager 214). The request may specify the system feature the requested seed value is representative of. For instance, in a non-limiting example, key generator 226 transmits a request for a seed value representative of a measurement taken by measurement device 210. In another non-limiting example, key generator 226 transmits a request for a seed value representative of a unique identifier of host computing device 200.

In step 406, the first seed value is received from the hardware component. For example, key generator 226 of FIG. 2 receives seed value 244d from hardware seed value generator 212. In this context, seed value 244d is any type of seed value hardware seed value generator 212 may be configured to generate, as described with respect to FIG. 2 and elsewhere herein.

Flowchart 400B of FIG. 4B is described with respect to key generator 226 transmitting a request to and receiving seed value 244d from hardware seed value generator 212; however, it is also contemplated herein that key generator 226 may transmit requests to and/or receive seed value 244d from other hardware components of host computing device 200. For instance, key generator 226 in accordance with an embodiment transmits a request to a measurement device (e.g., measurement device 210, a hardware-based TPM not shown in FIG. 2) for a seed value generated by and/or stored by the measurement device and receives, from the measurement device, seed value 244d. In another alternative embodiment, key generator 226 transmits a request to a processor of host computing device 200 (e.g., processor 206) for a seed value generated by the processor and receives, from the processor, seed value 244d.

As noted above, key generator 226 may receive seed values in various ways, in embodiments. FIG. 4C shows a flowchart 400C of another process for receiving a seed value representative of a system feature, in accordance with another embodiment. Flowchart 400C is a further embodiment of step 302 of flowchart 300, as described with respect to FIG. 3. Key generator 226 of FIG. 2 may operate according to flowchart 400C in embodiments. Note that not all steps of flowchart 400C need be performed in all embodiments. Further structural and operational embodiments will be apparent to persons skilled in the relevant art(s) based on the following descriptions of FIG. 4C with respect to FIG. 2.

Flowchart 400C begins with step 408. In step 408, a request for the first seed value is transmitted to a host service of the system. For example, key generator 226 of FIG. 2 transmits a request (not shown in FIG. 2) to virtual machine manager 214. The request may specify the system feature the requested seed value is representative of.

In step 410, the first seed value is received from the host service. For example, key generator 226 of FIG. 2 receives seed value 244c from virtual machine manager 214. In accordance with an embodiment, virtual machine manager 214 obtains seed value 244c from another component (e.g., hardware seed value generator 212) or service (e.g., seed value generator service 124) on behalf of key generator 226 and provides the obtained seed value 244c to key generator 226. In accordance with an alternative embodiment, virtual machine manager 214 provides seed value 244c representative of a system feature managed by virtual machine manager 214 (e.g., a system feature associated with host computing device 200 that virtual machine manager 214 has access to (e.g., geographic location and/or assignment data, software configuration data, a host operating system of host computing device 200, and/or the like, as described elsewhere herein), a system feature associated with VM instance 216 (e.g., the entity VM instance 216 and/or vTPM 222 is assigned to, the entity requesting to launch VM instance 216, an identifier of VM instance 216, and/or another feature of VM instance 216, as described elsewhere herein), and/or any other system feature virtual machine manager 212 is configured to provide a representative seed value for, as described elsewhere herein or as would otherwise be understood by a person skilled in the relevant art(s) having benefit of this disclosure.

As noted above, key generator 226 may receive seed values in various ways, in embodiments. FIG. 4D shows a flowchart 400D of another process for receiving a seed value representative of a system feature, in accordance with another embodiment. Flowchart 400D is a further embodiment of step 302 of flowchart 300, as described with respect to FIG. 3. Key generator 226 of FIG. 2 may operate according to flowchart 400D in embodiments. Note that not all steps of flowchart 400D need be performed in all embodiments. Further structural and operational embodiments will be apparent to persons skilled in the relevant art(s) based on the following descriptions of FIG. 4D with respect to FIG. 2.

Flowchart 400D begins with step 412. In step 412, a request for the first seed value is transmitted to a server of a cloud service platform associated with the virtual machine. For example, key generator 226 of FIG. 2 transmits a request (not shown in FIG. 2) to seed value generation service 124 (e.g., via virtual machine manager 214 and/or communication interfaces 208). The request may specify the system feature the requested seed value is representative of. For instance, in a non-limiting example, key generator 226 transmits a request for a seed value representative of a tenant vTPM 222 is assigned to.

In step 414, the first seed value is received from the server. For example, key generator 226 of FIG. 2 receives seed value 244b from seed value generation service 124. In this context, seed value 244b is any type of seed value seed value generation service 124 may be configured to generate, as described with respect to FIG. 1 and elsewhere herein.

Key generator 226 may be configured to generate keys in various ways, in embodiments. For instance, key generator 226 in accordance with an embodiment is configured to generate a key from multiple seed values. For example, FIG. 5 shows a flowchart 500 of a process for generating a key, in accordance with an embodiment. Key generator 226 of FIG. 2 may operate according to flowchart 500 in embodiments. Note that not all steps of flowchart 500 need be performed in all embodiments. Further structural and operational embodiments will be apparent to persons skilled in the relevant art(s) based on the following descriptions of FIG. 5 with respect to FIG. 2.

Flowchart 500 begins with step 502. In step 502, a second seed value representative of another system feature is received. For example, key generator 226 of FIG. 2 may be configured to receive two or more of seed values 244a-244d. Furthermore, in accordance with an alternative embodiment key generator 226 is configured to receive a second seed value from the same service and/or component as the first seed value received in step 302 of flowchart 300, as described with respect to FIG. 3. For instance, key generator 226 may receive a first seed value 244a and a second seed value (not shown in FIG. 2) from vTPM storage 228, receive a first seed value 244b and a second seed value (not shown in FIG. 2) from seed value generation service 124, receive a first seed value 244c and a second seed value (not shown in FIG. 2) from virtual machine manager 214, and/or receive a first seed value 244d and a second seed value (not shown in FIG. 2) from hardware seed value generator 212. In accordance with an embodiment, key generator 226 receives the second seed value concurrently with the first seed value. Alternatively, the first and second seed values are received sequentially or otherwise separate from each other (e.g., in response to different requests transmitted by key generator 226, from separate services and/or components, at different times, and/or the like).

Flowchart 500 continues to step 504, which may be a further embodiment of step 304 of flowchart 300, as described with respect to FIG. 3. In step 504, the first key is generated from the first seed value and the second seed value. For example, key generator 226 of FIG. 2 generates key 232 from the first seed value (e.g., the seed value received in step 302 of FIG. 3) and the second seed value (and/or any other seed values) received in step 502. In accordance with an embodiment, key generator 226 utilizes the first seed value and second seed value (and/or any other received seed values) as input to a mathematical formula to generate key 232. By computing keys from multiple seed values, vTPM 222 enables sealed state 246 (and/or other objects encrypted with and/or sealed by corresponding keys) to be bound to multiple security domains (and/or security sub-domains), thereby further improving computer security by reducing or preventing access to sealed state 246 (and/or other protected objects).

Virtual machines, such as VM instance 216 of FIG. 2, may be created, stopped, rebooted, and/or otherwise managed in various ways. For instance, if host computing device 200 is reset, virtual machine manager 214 and VM instance 216 will need to be rebooted. As another example, the flexibility of a virtual machine may allow the portion of memory 202 associated with VM instance 216 to be copied to or otherwise transferred to a different host computing device not shown in FIG. 2. These scenarios may pose a security risk. For instance, host computing device 200, a service executed by host computing device 200 and/or a component of host computing device 200 may be modified prior to VM instance 216 rebooting in a manner that would expose VM instance 216 to an unauthorized party. In the other example, the different host computing device may not meet criterion of an entity's policy for hosting VM instance 216. In either case, VM instance 216 and data accessible to VM instance 216 (e.g., an entity's keys and/or secrets) may be put at risk of exposure to an unauthorized party (e.g., a hacker). In accordance with embodiments described herein, vTPMs such as vTPM 222 reduce or prevent unauthorized access to unsealed or unencrypted objects.

To better illustrate techniques that reduce or prevent unauthorized access to unsealed or unencrypted objects, FIG. 2 will now be described with respect to FIG. 6. FIG. 6 shows a flowchart 600 of a process for determining whether to unseal a sealed state of an operating system, in accordance with an embodiment. Host computing device 200 may operate according to flowchart 600 in embodiments. Note that not all steps of flowchart 600 need be performed in all embodiments. Further structural and operational embodiments will be apparent to persons skilled in the relevant art(s) based on the following descriptions of FIG. 6 with respect to FIG. 2.

Flowchart 600 begins with step 602. In step 602, the vTPM is rebooted. For example, virtual machine manager 214 reboots VM instance 216 comprising vTPM 222. In embodiments, vTPM 222 may be rebooted for various reasons, including, but not limited to, an operation of an application executed by VM instance 216 requiring a reboot, VM instance 216 or a subservice thereof failing, virtual machine manager 214 initiating a reboot, virtual machine manager 214 rebooting, a failure in the operation of virtual machine manager 214, virtual machine manager 214 receiving a request to reboot VM instance 216 (e.g., from application 110 of FIG. 1), subsequent to VM instance 216 having otherwise been paused or stopped, subsequent to a failure in host computing device 200, and/or subsequent to or in response to any other scenario wherein vTPM 222 and/or VM instance 216 is to be rebooted, as would be understood by a person skilled in the relevant art(s) having benefit of this disclosure. In accordance with an embodiment, vTPM 222 is rebooted in a process similar to that described with respect to FIG. 2 (e.g., prior to step 302 of flowchart 300). For instance, vTPM 222 in accordance with an embodiment is rebooted based on VM firmware state 238. Alternatively, vTPM 222 is rebooted based on an updated VM firmware state, e.g., a VM firmware state sealed by the previous version of VM instance 216.

In step 604, a second seed value representative of the system feature is received. For example, key generator 226 of FIG. 2 receives a second seed value representative of the system feature the first seed value represented. For instance, as a non-limiting example, if the first seed value received in step 302 of flowchart 300 as described with respect to FIG. 3 was seed value 244d and representative of a measurement by measurement device 210, the second seed value received would also be received from hardware seed value generator 212 and representative of a measurement by measurement device 210. In accordance with an embodiment, the second seed value and the first seed value are equivalent in value. In an alternative embodiment, the second seed value has a different value from the first seed value.

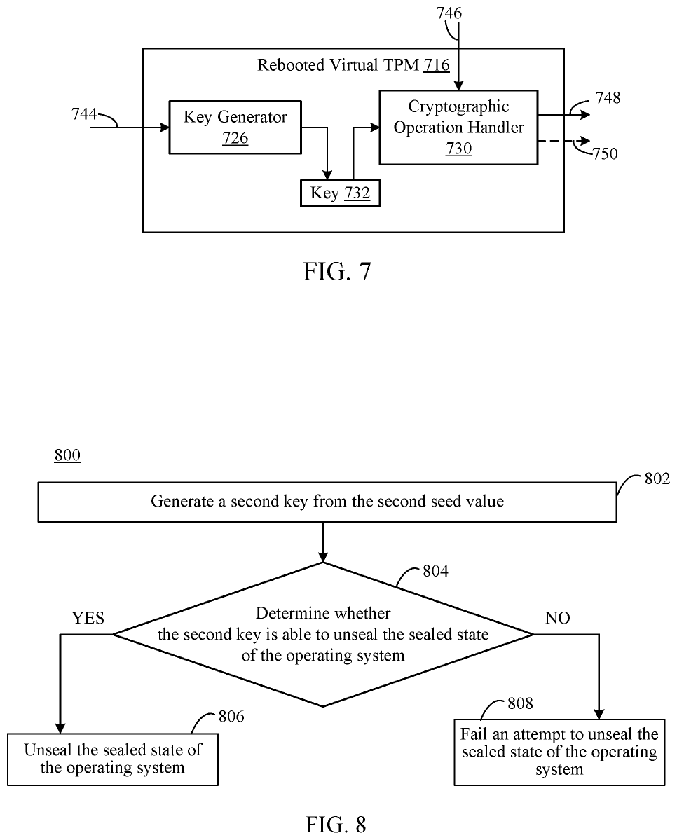

In step 606, a determination of whether the second seed value meets criterion for unsealing the unsealed state of the operating system. For example, key generator 226 and/or cryptographic operation handler 230 of FIG. 2 determines whether the second seed value received in step 604 meets criterion for unsealing a sealed state of VM operating system 234 (e.g., sealed state 246 or an updated version of sealed state 246). In accordance with an embodiment, key generator 226 determines whether the second seed value received in step 604 meets the criterion by comparing the second seed value with a stored version of the first seed value (or an updated seed value). In accordance with an alternative embodiment described further with respect to FIGS. 7 and 8, key generator 226 generates a new key and cryptographic operation handler 230 attempts to utilize the new key to determine whether the second seed value meets criterion for unsealing the sealed state of the operating system. If the second seed value is determined to meet the criterion for unsealing the sealed state of the operating system, flowchart 600 proceeds to step 608. Otherwise, flowchart 600 proceeds to step 610.

The second seed value may be determined to not meet the criterion for unsealing the sealed state for various reasons. For instance, suppose host computing device 200 was modified prior to rebooting vTPM 222. In this context, seed values associated with the hardware configuration of host computing device 200 and/or measurements made by measurement device 210 may be different from those received when the state was sealed, thereby indicating host computing device 200 no longer satisfies the criterion for unscaling the state. As another example, suppose vTPM 222 is rebooted on a different host computing device than host computing device 200, and the seed values associated with hardware configurations of the different host computing device and/or measurements made by a measurement device of the different host computing device may be different from those received when the state was sealed. In yet another example, suppose a setting of virtual machine manager 214 was modified to reduce security, and the seed values associated with the configuration of virtual machine manager 214 are different from those received when the state was sealed. In yet another example, suppose the VM firmware was tampered with prior to vTPM 222 generating the key to be used for unsealing the sealed state of the VM operating system. In this example, seed values associated with the VM firmware disk and/or VM instance 216 may be different from those received when the state was sealed.

In step 608, the sealed state of the operating system is unsealed. For example, cryptographic operation handler 230 of FIG. 2 utilizes the new key to unseal sealed state 246 (or the updated version of sealed state 246). Cryptographic operation handler 230 may utilize the new key in a similar manner as described with respect to key 232 and step 306 of FIG. 3, as well as elsewhere herein. Subsequent to the sealed state being unsealed, cryptographic operation handler 230 may provide the unsealed state to guest boot manager 224 for rebooting VM operating system 234.

In step 610, unsealing the sealed state of the operating system fails. For example, if the second seed value does not meet the criterion for unsealing sealed state 246 (or the updated version of sealed state 246), cryptographic operation handler 230 fails to unseal the sealed state. In accordance with an embodiment, in response to failing to unseal the sealed state, vTPM 222 causes virtual machine manager 214 to stop or otherwise shut down VM instance 216. In accordance with an embodiment, in response to failing to unseal the sealed state, vTPM 222 or virtual machine manager 214 transmits a notification (e.g., to the entity associated with VM instance 216, the entity associated with host computing device 200, and/or a computing device of the entity associated with VM instance 216 and/or host computing device 200) indicating booting VM instance 216 failed.

As noted above, a vTPM may reboot (e.g., in the same host computing device or in a different host computing device) and be configured to determine whether seed values meet criterion for unsealing an operating system state of a virtual machine. A rebooted TPM may be configured in various ways, in embodiments. For instance, FIG. 7 shows a block diagram of a system 700 comprising a rebooted vTPM 716, in accordance with an embodiment. As shown in FIG. 7, rebooted vTPM 716 comprises a key generator 726 and a cryptographic operation handler 730, each of which are further respective embodiments of key generator 226 and cryptographic operation handler 230, as described with respect to FIG. 2. As also shown in FIG. 7, key generator 726 is configured to generate a key 732 and cryptographic operation handler 730 is configured to utilize key 732. Key 732 may be stored in a similar manner as other keys generated by vTPMs, as described elsewhere herein. For instance, key 732 may be stored in a secured portion of memory of the host computing device executing rebooted vTPM 716 (not shown in FIG. 7 for brevity).

To better understand the operation of a rebooted vTPM, rebooted vTPM 716 of FIG. 7 is described with respect to FIG. 8. FIG. 8 shows a flowchart 800 of a process for determining whether a key is able to unseal a sealed state of an operating system, in accordance with an embodiment. Flowchart 800 is a further embodiment of steps 606-610 of flowchart 600, as described with respect to FIG. 6. In an embodiment, vTPM 716 may operate according to flowchart 800. Note that not all steps of flowchart 800 need be performed in all embodiments. Further structural and operational embodiments will be apparent to persons skilled in the relevant art(s) based on the following descriptions of FIG. 8 with respect to FIG. 7.

Flowchart 800 begins with step 802. In step 802, a second key is generated from the second seed value. For instance, key generator 726 receives a seed value 744 and generates key 732 from seed value 744. Key generator 726 may generate key 732 from seed value 744 in various ways, as described elsewhere herein. In accordance with an embodiment, key generator 726 receives multiple seed values (including seed value 744) and generates key 732 from the multiple seed values.

In step 804, a determination of whether the second key is able to unseal the sealed state of the operating system is made. For example, cryptographic operation handler 730 determines whether key 732 is able to unseal a sealed state 746 of the operating system. In an embodiment, sealed state 746 is the same sealed state the previous vTPM unsealed. Alternatively, sealed state 746 is an updated sealed state sealed by the previous vTPM prior to the vTPM rebooting. In accordance with an embodiment, the determination is made by cryptographic operation handler 730 utilizing key 732 to attempt to unseal sealed state 746. If key 732 is able to unseal sealed state 746, flowchart 800 proceeds to step 806. Otherwise, flowchart 800 proceeds to step 808.

Step 806 may be a further embodiment of step 608, as described with respect to FIG. 6. In step 806, the sealed state of the operating system is unsealed. For example, suppose key 732 is able to unseal sealed state 746 (e.g., based on the attempt and/or determination made in step 804). In this example, cryptographic operation handler 730 utilizes key 732 to unseal sealed state 746. Cryptographic operation handler 730 is configured to provide unsealed state 748 to the VM instance or a component or subservice thereof (e.g., guest boot manager 224 of FIG. 2) to cause the VM instance (or component or subservice thereof) to boot the VM operating system based on unsealed state 748.

Step 808 may be a further embodiment of step 610, as described with respect to FIG. 6. In step 808, an attempt to unseal the sealed state of the operating system failed. For example, suppose key 732 is unable to unseal sealed state 746. In this example, cryptographic operation handler 730 fails to unseal sealed state 746. In accordance with an embodiment, and as optionally shown in FIG. 7, cryptographic operation handler 730, subsequent to failing to unseal sealed state 746, generates a notification 750 indicating the attempt to unseal sealed state 746 failed. In accordance with an embodiment, cryptographic operation handler 730 provides notification 750 to the virtual machine manager managing rebooted vTPM 716 (e.g., virtual machine manager 214 of FIG. 2), to an entity associated with the VM instance (e.g., VM instance 216), to a computing device associated with the entity (e.g., computing device 102 of FIG. 1). In accordance with a further embodiment, notification 750 causes the virtual machine manager managing rebooted TPM 716 to stop the associated VM instance.

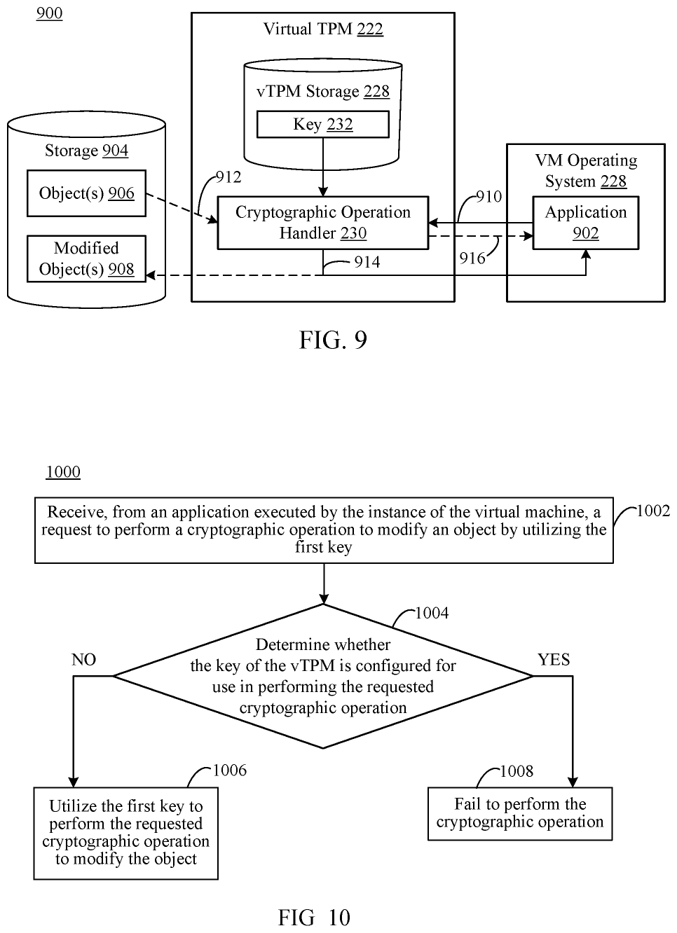

As discussed elsewhere herein, embodiments of vTPMs provide a tamper-resistant platform for performing security functions such as cryptographic operations. Several example cryptographic operations related to unsealing an operating state of a virtual machine have been described with respect to FIGS. 2-8, as well as elsewhere herein. It is also contemplated herein that vTPMs, such as vTPM 222 of FIG. 2, may be configured to perform other types of cryptographic operations to modify objects. For instance, vTPM 222 may be configured to perform cryptographic operations to seal an object, unseal an object, sign an object, verify an object (e.g., verify a signature that signs the object), decrypt an object, encrypt an object, and/or otherwise modify an object. In embodiments, vTPM 222 may be configured to perform cryptographic operations in various ways. For example, FIG. 9 shows a block diagram of a system 900 for performing a cryptographic operation, in accordance with an embodiment. As shown in FIG. 9, system 900 comprises vTPM 216 (comprising vTPM storage 228 and cryptographic operation handler 230) and VM operating system 228 as described with respect to FIG. 2, and a storage 904. As also shown in FIG. 9, VM operating system 228 comprises an application 902. Application 902 is any type of application executable in VM operating system 228. In accordance with an embodiment, application 902 is hosted by VM operating system 228 on behalf of an entity (e.g., the entity corresponding to computing device 102 of FIG. 1).

Storage 904 may be a further example of vTPM storage 228, a further example of storage 108, a storage separate from vTPM storage 228 and storage 108, and/or a combination of vTPM storage 228, storage 108, and/or additional storage. As shown in FIG. 9, storage 904 stores one or more objects 906 (“objects 906” hereinafter) and one or more modified objects 908 (“modified objects 908” hereinafter). Objects 906 comprise any number of states of operating systems of virtual machines, firmware states of virtual machines, cryptographic keys, data, application states, and/or the like. Any of objects 906 may be stored in storage 904 as an encrypted (or sealed) version of the corresponding object. Modified objects 908 comprise any number of objects modified by cryptographic operation handler 230, as described further with respect to FIG. 10, as well as elsewhere herein.

To better illustrate embodiments of performing a cryptographic operation to modify an object, system 900 is further described with respect to FIG. 10. FIG. 10 shows a flowchart 1000 of a process for performing a cryptographic operation, in accordance with an embodiment. In embodiments, vTPM 222 of FIG. 9 of FIG. 9 may operate according to flowchart 1000. Note that not all steps of flowchart 1000 need be performed in all embodiments. Further structural and operational embodiments will be apparent to persons skilled in the relevant art(s) based on the following descriptions of FIGS. 9 and 10.

Flowchart 1000 begins with step 1002. In step 1002, a request to perform a cryptographic operation to modify an object by utilizing the first key is received from an application executed by the instance of the virtual machine. For example, cryptographic operation handler 230 of FIG. 7 receives, from application 902, a request 910 to perform a cryptographic operation to modify an object by utilizing key 232. In accordance with an embodiment, request 910 comprises the object to be modified by the cryptographic operation. Alternatively, and as shown in FIG. 7, cryptographic operation handler 230 obtains an object 912 from objects 906 stored by storage 904. In this alternative embodiment, request 910 includes an identifier that uniquely identifies object 912 and cryptographic operation handler 230 obtains object 912 based on the identifier. In accordance with an embodiment, request 910 indicates the type of cryptographic operation to be performed. In accordance with another embodiment, request 910 indicates a security domain to which the cryptographic operation is to be performed. For instance, in scenarios where request 910 is a request to seal or encrypt object 912 (or the object included in request 910), request 910 indicates which security domain the object is to be sealed and/or encrypted to.

In step 1004, a determination of whether the key of the vTPM is configured for use in performing the requested cryptographic operation. For example, cryptographic operation handler 230 determines whether key 232 is configured for use in performing the cryptographic operation requested by request 910 to modify object 912 (or the object included in request 910). In accordance with an embodiment, cryptographic operation handler 230 determines whether key 232 is configured for use in performing the requested operation by attempting to utilize key 232 to perform the cryptographic operation. If cryptographic operation handler fails to perform the operation using key 232, flowchart 1000 proceeds to step 1008. If cryptographic operation handler succeeds in performing the operation using key 232, flowchart 1000 proceeds to step 1006.

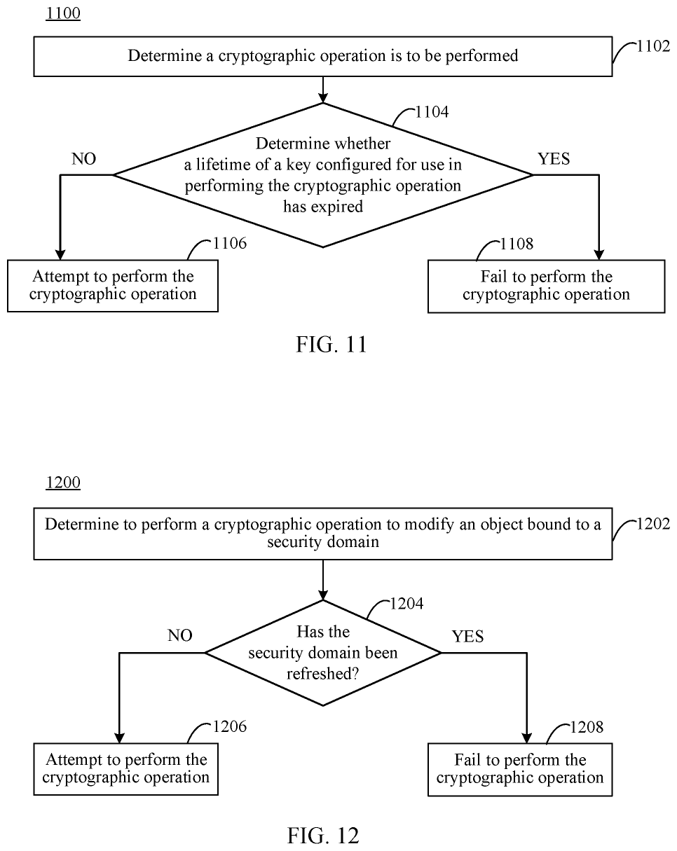

Cryptographic operation handler 230 may determine whether key 232 is configured for use in performing the requested operation in other ways, as described elsewhere herein. For example, in accordance with another embodiment described further with respect to FIG. 11, cryptographic operation handler 230 determines whether key 232 is configured for use in performing the requested operation based on a lifetime of key 232. In accordance with another embodiment, and as described further with respect to FIG. 12, cryptographic operation handler 230 determines whether key 232 is configured for use in performing the requested operation based on whether a security domain has been refreshed (e.g., updated or otherwise changed). In any of the aforementioned examples, if the key is determined to be configured for use in performing the requested cryptographic operation, flowchart 1000 proceeds to step 1006. Otherwise, flowchart 1000 proceeds to step 1008.

In step 1006, the first key is utilized to perform the request cryptographic operation to modify the object. For example, cryptographic operation handler 230 utilizes key 232 to perform the cryptographic operation requested by request 910 to modify object 912 (or the object included in request 910), thereby generating modified object 914. In accordance with an embodiment, modified object 914 is provided to application 902 subsequent to performing the requested cryptographic operation. Alternatively, or additionally, modified object 914 is stored in storage 904 as one of modified objects 908.

In step 1008, the performance of the cryptographic operation fails. For example, if cryptographic operation handler 230 fails an attempt to perform the cryptographic operation utilizing key 232, cryptographic operation handler 230 fails to perform the operation. Alternatively, if cryptographic operation handler 230 otherwise determines key 232 is not configured for use in performing the cryptographic operation (e.g., based on a lifetime of key 232, based on whether a security domain has been refreshed, etc.), cryptographic operation handler 230 fails to perform (e.g., by denying the performance of) the cryptographic operation. In accordance with an embodiment, and as shown in FIG. 9, cryptographic operation handler 230 transmits a notification 916 to application 902 that indicates the cryptographic operation failed. Notification 916 in accordance with a further embodiment indicates the reason the operation failed (e.g., key 232 is not configured for use in performing the requested operation, a lifetime of key 232 has expired, a security domain associated with key 232 and/or object 906 has been refreshed, and/or any other reason in which cryptographic operation handler 230 would fail to perform the requested operation, as described elsewhere herein). Alternatively, or additionally, cryptographic operation handler 230 transmits a notification (not shown in FIG. 9 for brevity) to an entity associated with VM instance 216, the entity associated with host computing device 200, and/or a computing device of the entity associated with VM instance 216 and/or host computing device 200) indicating the cryptographic operation failed (and optionally the reason for the failure).

Cryptographic operation handler 230 may perform the requested cryptographic operation in various ways. For instance, cryptographic operation handler 230 may determine if key 232 is able to perform the requested cryptographic operation. In accordance with an embodiment, cryptographic operation handler 230 attempts to perform the requested cryptographic operation and, if the cryptographic operation fails (e.g., key 232 is unable to perform the operation), generates a notification in a similar manner as described with respect to step 610 of FIG. 6 and/or step 808 of FIG. 8.

As noted above, request 910 may indicate an object is to be sealed and/or encrypted to a particular security domain and/or combination of security domains. In some embodiments, the requested security domain(s) correspond to the same security domain key 232 is representative above. For instance, suppose request 910 indicates object 912 is to be sealed to a hardware security domain and key 232 is a key generated from seed values representative of a hardware security domain. However, it is also contemplated herein that request 910 may indicate an object is to be sealed and/or encrypted to a security domain or security domains other than (or in addition to) the security domain(s) key 232 is representative of. For instance, suppose application 902 requires the object to be protected by additional security policies. In this example scenario, request 910 indicates the cryptographic operation is to be performed with respect to the security domain key 232 is representative of and an additional security domain (or subdomain). As a non-limiting example, suppose request 910 indicates the object is to be sealed to VM instance 216 (e.g., sealed to a VM instance domain). In this example, cryptographic operation handler 230 may transmit a request (not shown in FIG. 9) to key generator 226 of FIG. 2 to cause key generator 226 to generate a key suitable for sealing (or encrypting) the object to the security domain indicated in request 910. Alternatively, cryptographic operation handler 230 may obtain a previously generated key stored in vTPM storage 228 (not shown in FIG. 9) that corresponds to the security domain indicated in request 910. By enabling cryptographic operation handler 230 to perform cryptographic operations using keys other than the key generated to unseal the operating state of the VM instance in this way, embodiments described herein allow increased flexibility in determining which system(s) are able to access (e.g., an unsealed and/or decrypted version of) modified object 914. These techniques may be used to further increase computer security with respect to a particular object (e.g., by increasing the criteria a system must satisfy in order to access the unsealed and/or decrypted version of modified object 914).

### III. Further Example Embodiments

### A. Example Time Out Embodiments

Embodiments of vTPMs are described herein with respect to performing cryptographic operations utilizing keys generated from seed values representative of system features. In some embodiments, a key may be assigned a lifetime. In this context, a “lifetime” is a period of time in which the key is valid for use in performing cryptographic operations. In accordance with one or more embodiments, a lifetime may be any number of minutes, hours, days, weeks, and/or the like. Lifetimes may be assigned to a key based on a policy of vTPM 222 or based on a policy an object is protected by. In embodiments, vTPM 222 of FIG. 2 may be configured to determine whether or not a lifetime of a key has expired in various ways. For instance, FIG. 11 shows a flowchart 1100 of a process for determining whether a lifetime of a key has expired, in accordance with an embodiment. In embodiments, vTPM 222 may operate according to flowchart 1100. Note not all steps of flowchart 1100 need be performed in all embodiments. Further structural and operational embodiments will be apparent to persons skilled in the relevant art(s) based on the following descriptions of FIG. 11 with respect to FIG. 2.

Flowchart 1100 begins with step 1102. In step 1102, a cryptographic operation is determined to be performed. For example, vTPM 222 of FIG. 2 may determine to perform (or automatically perform) a cryptographic operation to unseal a state of an operating system, e.g., as described with respect FIGS. 2 and 3, and elsewhere herein. Alternatively, vTPM 222 of FIG. 2 may determine to perform a cryptographic operation in response to a request (e.g., a request from application 902 (e.g., as described with respect to FIGS. 9 and 10)) to perform the cryptographic operation. In either scenario, vTPM 222 (or a component thereof) determines to perform a cryptographic operation and flowchart 1100 proceeds to step 1104.

In step 1104, a determination of whether a lifetime of a key has expired is made, the key configured for use in performing the cryptographic operation. For example, cryptographic operation handler 230 of FIG. 2 determines whether a lifetime of key 232 has expired. Cryptographic operation handler 230 may determine whether the lifetime of key 232 has expired in various ways. For instance, in accordance with an embodiment, key generator 226 assigns a lifetime to key 232 and stores with key 232 (e.g., in vTPM storage 228). Alternatively, key generator 226 stores an indication of the time key 232 was generated with key 232 (e.g., in vTPM storage 228). In this alternative embodiment, cryptographic operation handler 230 analyzes the time key 232 was generated, a lifetime set by a policy associated with the determined cryptographic operation, and the current time to determine whether or not a lifetime of key 232 has expired. In any of the described scenarios, if the lifetime of the key is determined to have not expired, flowchart 1100 continues to step 1106. Otherwise, flowchart 1100 continues to step 1108.

In step 1106, an attempt to perform the cryptographic operation is made. For example, suppose the lifetime of key 232 has not expired. In this context, cryptographic operation handler 230 of FIG. 2 attempts to perform the cryptographic operation (e.g., unsealing a sealed state and/or performing another cryptographic operation, as described herein). In this context, the attempt may succeed (e.g., key 232 is configured to perform the cryptographic operation) or not succeed (e.g., key 232 is otherwise not configured to perform the cryptographic operation), as described elsewhere herein.

In step 1108, the performance of the cryptographic operation fails. For example, suppose the lifetime of key 232 has expired. In this context, cryptographic operation handler 230 of FIG. 2 fails to perform the cryptographic operation. In accordance with an embodiment, cryptographic operation handler 230 generates a notification that the performance of the cryptographic operation failed (e.g., as described elsewhere herein). In accordance with another embodiment, cryptographic operation handler 230 transmits a request to key generator 226 to generate an updated key. In accordance with a further embodiment, this request causes key generator 226 to re-obtain seed values (e.g., updated seed values) to generate an updated key. In this context, vTPM 222 enables updating keys used for performing (or attempting to perform) cryptographic operations based on seed values obtainable by key generator 226 (e.g., without having to reboot vTPM 222 and/or VM instance 216).

Flowchart 1100 of FIG. 11 has been described with respect to lifetimes of keys generated by key generator 226; however, it is also contemplated herein that a lifetime may be assigned to a seed value. For instance, vTPM 222 may store seed values received by key generator 226 (e.g., in a secure memory accessible (e.g., only) to vTPM 222 (e.g., vTPM storage 228)) for use in generating keys. By storing seed values in this way, vTPM 222 is able to regenerate key 232 or generate other keys from the stored seed values (e.g., a key for performing a cryptographic operation as described with respect to FIGS. 9 and 10) without additional communication between vTPM 222 and the original providing component or service of the seed value, thereby reducing compute resources used to generate keys subsequent to an initial key generation. However, to increase security with respect to seed values and generation of cryptographic keys, a seed value may be assigned a lifetime (or an expiration time) to cause the seed value to no longer be suitable for generating cryptographic keys. In this context, key generator 226 may determine whether or not a lifetime for a particular seed value has expired prior to generating a key from the seed value.

### B. Example Refresh Embodiments

Embodiments of vTPMs are described herein with respect to performing cryptographic operations utilizing keys generated from seed values representative of system features. Furthermore, as described with respect to FIG. 11, a key may be assigned a lifetime, or a period of time in which the key is valid for use in performing cryptographic operations. Alternatively, or additionally, a lifetime for a key may be determined (e.g., indirectly) based on a refresh of a security domain. In this context, if a security domain is refreshed, the seed values associated with the security domain are also refreshed (e.g., updated to new values). Therefore, any keys generated from the previous seed values are different from the keys generated from a refreshed seed value. In embodiments, vTPM 222 of FIG. 2 may be configured to determine whether or not a security domain has been refreshed (e.g., refreshed since a key was updated). For instance, FIG. 12 shows a flowchart 1200 of a process for determining whether a key is to be refreshed, in accordance with an embodiment. In embodiments, vTPM 222 may operate according to flowchart 1200. Note not all steps of flowchart 1200 need be performed in all embodiments. Further structural and operational embodiments will be apparent to persons skilled in the relevant art(s) based on the following descriptions of FIG. 12 with respect to FIG. 2.

Flowchart 1200 begins with step 1202. In step 1202, a cryptographic operation is determined to be performed. The cryptographic operation is to modify an object bound to a security domain. For example, vTPM 222 of FIG. 2 may determine to perform (or automatically perform) a cryptographic operation to unseal a state of an operating system bound to the security domain, e.g., as described with respect FIGS. 2 and 3, and elsewhere herein. Alternatively, vTPM 222 of FIG. 2 may determine to perform a cryptographic operation in response to a request (e.g., a request from application 902 (e.g., as described with respect to FIGS. 9 and 10)) to perform the cryptographic operation to modify an object bound to the security domain. In either scenario, vTPM 222 (or a component thereof) determines to perform a cryptographic operation and flowchart 1200 proceeds to step 1204.

In step 1204, a determination of whether a security domain has been refreshed is made. For example, cryptographic operation handler 230 of FIG. 2 determines whether the security domain has been refreshed. For instance, cryptographic operation handler 230 determines whether a security domain has been refreshed since the object was bound to the security domain. In this context, key 232 may no longer be suitable for performing the cryptographic operation, since the seed values used to generate key 232 may have changed from the seed values used to generate the key that bound the object to the security domain. In accordance with an embodiment, cryptographic operation handler 230 determines the security domain has refreshed by attempting to perform the cryptographic operation using key 232. If the operation succeeds, the security domain has not refreshed and flowchart 1200 continues as described with respect to step 1206. Otherwise, flowchart 1200 continues as described with respect to 1208. In accordance with an alternative embodiment, cryptographic operation handler 230 (or another component of virtual TPM 222, not shown in FIG. 2 for brevity) maintains a record of security domain refreshes and when objects are bound to the security domain. If records indicate the object was bound to the security domain prior to the refresh, cryptographic operation determines the security domain has been refreshed and flowchart 1200 continues as described with respect to step 1208. Otherwise, flowchart 1200 continues to step 1206.

In step 1206, an attempt to perform the cryptographic operation is made. For example, suppose the security domain has not been refreshed. In this context, cryptographic operation handler 230 of FIG. 2 attempts to perform the cryptographic operation (e.g., unscaling a sealed state and/or performing another cryptographic operation, as described herein). The attempt may succeed (e.g., key 232 is configured to perform the cryptographic operation) or fail to succeed (e.g., key 232 is otherwise not configured to perform the cryptographic operation), as described elsewhere herein.

In step 1208, the performance of the cryptographic operation fails. For example, suppose the security domain the object is bound to has refreshed. In this context, cryptographic operation handler 230 of FIG. 2 fails to perform the cryptographic operation (e.g., because key 232 corresponds to the refreshed version of the security domain and not the original version of the security domain the object is bound to). In accordance with an embodiment, cryptographic operation handler 230 generates a notification that the performance of the cryptographic operation failed (e.g., as described elsewhere herein).

To better illustrate embodiments wherein a security domain is refreshed, steps 1204 and 1206 of flowchart 1200 are described with respect to several non-limiting examples. For instance, in a first a non-limiting example, suppose the state of VM operating system 234 of FIG. 2 was bound to a particular hardware (e.g., a hardware security domain) other than host computing device 200. In this context, a first key corresponding to the hardware (e.g., generated based on seed values representative of system features of the hardware security domain) is used to bind the state of VM operating system 234 to the hardware. Further suppose key 232 is generated based on seed values representative of the hardware security domain of host computing device 200. In this context, vTPM 222 generates (or otherwise obtains) key 232 and attempts to unseal the state of VM operating system 234; however, since the hardware security domain (e.g., host computing device 200) has changed from the hardware security domain the state of VM operating system 234 is bound to (i.e., the hardware security domain has “refreshed”), vTPM 222 is unable to unseal the state of VM operating system 234 and flowchart 1200 continues to step 1208.

As a second non-limiting example, suppose the state of VM operating system 234 of FIG. 2 was bound to a first region (e.g., a geographic domain) other than the region host computing device 200 is located in. In this context, a first key corresponding to the first region (e.g., generated based on seed values representative of system features of the geographic region domain) is used to bind the state of VM operating system 234 to the first region. Further suppose key 232 is generated based on seed values representative of the region domain of host computing device 200. In this context, vTPM 222 generates (or otherwise obtains) key 232 and attempts to unseal the state of VM operating system 234; however, since the region security domain (e.g., where host computing device 200 is located) has changed from the region security domain the state of VM operating system 234 is bound to (i.e., the region security domain has “refreshed”), vTPM 222 is unable to unseal the state of VM operating system 234 and flowchart 1200 continues to step 1208.

### C. Example Embodiments for Receiving Keys

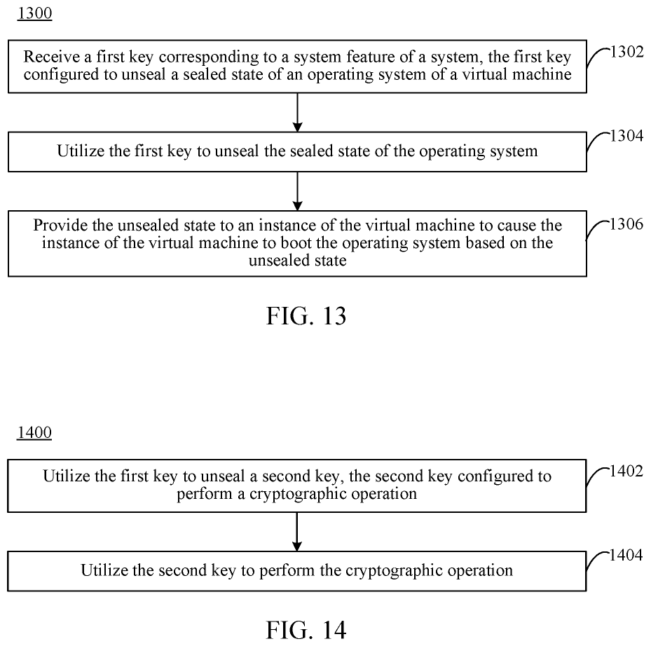

Embodiments have been described with respect to vTPMs generating keys from seed values. However, vTPMs may receive or otherwise obtain keys in other ways. For instance, a vTPM in accordance with an embodiment may obtain a key from a secure portion of memory accessible to the vTPM (e.g., in a similar manner as described with respect to obtaining seed values in flowchart 400A of FIG. 4A). Alternatively, a vTPM may receive a key from an application, a host service, a hardware component, a server of a cloud service platform, and/or any other type of application, device and/or other entity that stores, generates and/or otherwise maintains keys corresponding to system features of a system (or security domains of a system), as described elsewhere herein. A vTPM may operate in various ways to receive keys and utilize the received keys, in embodiments. For instance, FIG. 13 shows a flowchart 1300 of a process for utilizing a received key to unseal a sealed state of an operating system, in accordance with an embodiment. In embodiments, vTPM 222 of FIG. 2 may operate according to flowchart 1300. Note not all steps of flowchart 1300 need be performed in all embodiments. Further structural and operational embodiments will be apparent to persons skilled in the relevant art(s) based on the following descriptions of FIG. 13 with respect to FIG. 2.

Flowchart 1300 begins with step 1302. In step 1302, a first key is received. The first key corresponds to a system feature of a system and is configured to unseal a sealed state of an operating system of a virtual machine. For example, cryptographic operation handler 230 of FIG. 2 receives a first key (e.g., key 232) corresponding to a system feature of the system comprising host computing device 200 (e.g., system 100 of FIG. 1). In embodiments, cryptographic handler 230 may receive the first key from vTPM storage 228, from a key management service (e.g., a key management service of service provider system 106 of FIG. 1, not shown for brevity), from a hardware component of host computing device 200 (e.g., a physical TPM of host computing device 200, not shown for brevity), from an application executed by host computing device 200, and/or the like. In accordance with an embodiment, vTPM 222 receives the key subsequent to installation on (or booting on) host computing device 200 (i.e., after being launched by TPM launch operation 240) and prior to booting VM operating system 234. In accordance with another embodiment, vTPM 222 (or a secure portion of memory accessible to vTPM 222) is preconfigured with the first key. In accordance with another embodiment, vTPM 222 receives the key in (or in response to) a request to perform a cryptographic operation. In accordance with another embodiment, vTPM 222 receives the key in response to transmitting a request to a service and/or device to provide the key. In accordance with an embodiment, vTPM 222 stores the received key in storage accessible to vTPM 222 (e.g., vTPM storage 228).

In step 1304, the first key is used to unseal the sealed state of the operating system. For example, cryptographic operation handler 230 of FIG. 2 utilizes the first key (e.g., key 232) to unseal a sealed state 246 of VM operating system 234. Cryptographic operation handler 230 receives or otherwise obtains sealed state 246 in any manner described with respect to step 306 of flowchart 300 of FIG. 3, as well as elsewhere herein. If cryptographic operation handler 230 is successfully able to unseal sealed state 246, flowchart 300 continues to step 308.

In step 1306, the unsealed state is provided to an instance of the virtual machine to cause the instance of the virtual machine to install the operating system based on the unsealed state. For example, cryptographic operation handler 230 of FIG. 2 provides unsealed state 248 to guest boot manager 224 of VM instance 216 to cause guest boot manager 224 to boot VM operating system 234 based on unsealed state 248. By preventing booting VM operating system 234 until the operating state is unsealed in this way, vTPM 222 improves computer security by reducing or preventing access to unsealed state 248 (which may enable access to an entity's secrets) on unauthorized hardware, in an unauthorized region, in an unauthorized VM instance, and/or in an otherwise unauthorized system. Furthermore, by utilizing keys received from a service and/or device, vTPM 222 performs cryptographic operations without generating keys from seed values, thereby conserving resources utilized to perform or otherwise enable the performance of such operations.

Flowchart 1300 has been described with respect to unsealing a sealed state of a VM operating system. However, vTPMs such as vTPM 222 of FIG. 2 may be configured to receive keys configured to perform other types of cryptographic operations, as described herein. For instance, vTPM 222 may be configured to receive a key configured to perform any of the cryptographic operations described with respect to FIGS. 9-12, as well as elsewhere herein.

### D. Example Embodiments for Unsealing Keys

Embodiments have been described with respect to utilizing keys to perform cryptographic operations with respect to objects (e.g., unsealing states of VM operating systems and/or other cryptographic operations described elsewhere herein). A vTPM, such as vTPM 222 of FIG. 2, may be configured to perform cryptographic operations in various ways, in embodiments. For instance, FIG. 14 shows a flowchart 1400 of a process for performing a cryptographic operation, in accordance with an embodiment. In accordance with an embodiment, flowchart 1400 is a further embodiment of step 306 of flowchart 300 of FIG. 3, step 1004 of flowchart 1000 of FIG. 10, step 1304 of flowchart 1300 of FIG. 13, and/or any other operation or function to perform a cryptographic operation, as described elsewhere herein and/or as would be understood by a person skilled in the relevant art(s) having benefit of this disclosure. In embodiments, vTPM 222 of FIG. 2 may operate according to flowchart 1400. Note not all steps of flowchart 1400 need be performed in all embodiments. Further structural and operational embodiments will be apparent to persons skilled in the relevant art(s) based on the following descriptions of FIG. 14 with respect to FIG. 2.

Flowchart 1400 starts with step 1402. In step 1402, the first key is used to unseal a second key. The second key is configured to perform a cryptographic operation. For example, cryptographic operation handler 230 of FIG. 2 utilizes key 232 to unseal a second key (not shown in FIG. 2 for brevity). The second key may be a key generated by key generator 226 or a key otherwise obtained by vTPM 222. The second key may correspond to the same and/or different system features as the first key. In accordance with an embodiment, the sealed version of the key is stored in vTPM storage 228.

In step 1404, the second key is used to perform the cryptographic operation. For example, cryptographic operation handler 230 of FIG. 2 utilizes the second key to perform a cryptographic operation (e.g., unsealing the sealed state 246, modifying object 912, and/or performing another cryptograph operation described elsewhere herein). By sealing the second key configured to perform the cryptographic operation with a first key, vTPM 222 enables binding objects and/or otherwise performing particular cryptographic operations to different security domains. For instance, the first key (e.g., key 232) in an example embodiment corresponds to a first security domain that (e.g., all) cryptographic operations performed by vTPM 222 are performed to. In this example, the second key (also referred to as a nested key) corresponds to a second security domain (e.g., different from the first) that a particular object is bound to or a particular type of cryptographic operation is to be performed with respect to. In this manner, vTPM 222 enables an entity to flexibly select which security domains (based on the keys and/or nested keys) a cryptographic operation is to be performed to or an object is to be bound to.

### IV. Example Computer System Implementation

As noted herein, the embodiments described, along with any circuits, components and/or subcomponents thereof, as well as the flowcharts/flow diagrams described herein, including portions thereof, and/or other embodiments, may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC), a field programmable gate array (FPGA), and/or an application specific integrated circuit (ASIC). A SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

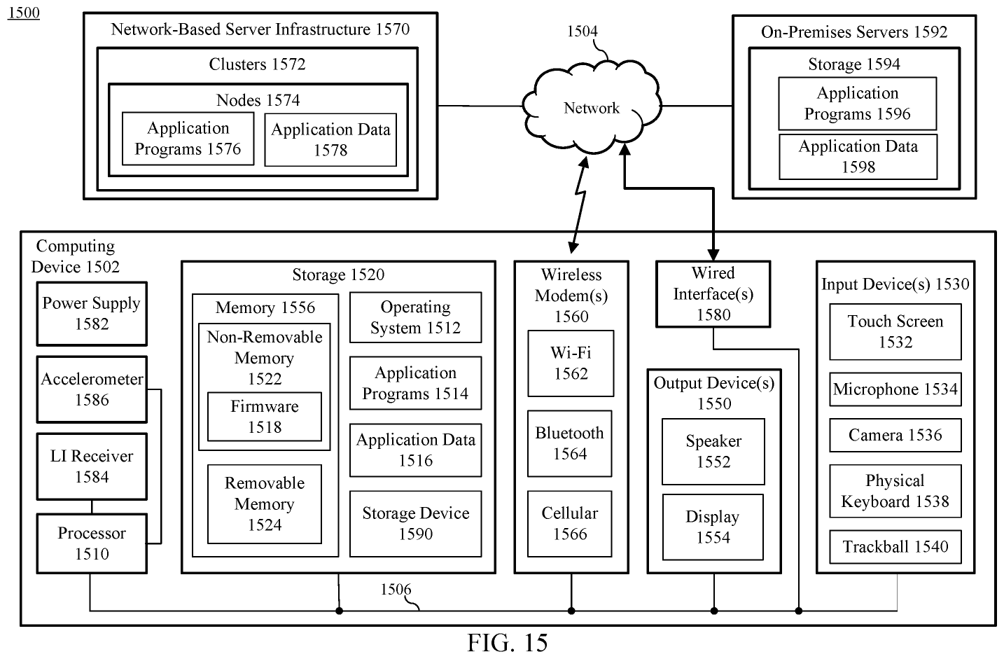

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 15. FIG. 15 shows a block diagram of an exemplary computing environment 1500 that includes a computing device 1502. Computing device 1502 is an example of computing device 102, server infrastructure 104, service provider system 106, host computing device 112A, and/or host computing device 112n of FIG. 1, host computing device 200 of FIG. 2, system 700 of FIG. 7, and/or system 900 of FIG. 9, each of which may include one or more of the components of computing device 1502. In some embodiments, computing device 1502 is communicatively coupled with devices (not shown in FIG. 15) external to computing environment 1500 via network 1504. Network 1504 is an example of network 132 of FIG. 1 and comprises one or more networks such as local area networks (LANs), wide area networks (WANs), enterprise networks, the Internet, etc., and may include one or more wired and/or wireless portions. Network 1504 may additionally or alternatively include a cellular network for cellular communications. Computing device 1502 is described in detail as follows.

Computing device 1502 can be any of a variety of types of computing devices. For example, computing device 1502 may be a mobile computing device such as a handheld computer (e.g., a personal digital assistant (PDA)), a laptop computer, a tablet computer (such as an Apple iPad™), a hybrid device, a notebook computer (e.g., a Google Chromebook™ by Google LLC), a netbook, a mobile phone (e.g., a cell phone, a smart phone such as an Apple® iPhone® by Apple Inc., a phone implementing the Google® Android™ operating system, etc.), a wearable computing device (e.g., a head-mounted augmented reality and/or virtual reality device including smart glasses such as Google® Glass™, Oculus Rift® of Facebook Technologies, LLC, etc.), or other type of mobile computing device. Computing device 1502 may alternatively be a stationary computing device such as a desktop computer, a personal computer (PC), a stationary server device, a minicomputer, a mainframe, a supercomputer, etc.

As shown in FIG. 15, computing device 1502 includes a variety of hardware and software components, including a processor 1510, a storage 1520, one or more input devices 1530, one or more output devices 1550, one or more wireless modems 1560, one or more wired interfaces 1580, a power supply 1582, a location information (LI) receiver 1584, and an accelerometer 1586. Storage 1520 includes memory 1556, which includes non-removable memory 1522 and removable memory 1524, and a storage device 1590. Storage 1520 also stores an operating system 1512, application programs 1514, and application data 1516. Wireless modem(s) 1560 include a Wi-Fi modem 1562, a Bluetooth modem 1564, and a cellular modem 1566. Output device(s) 1550 includes a speaker 1552 and a display 1554. Input device(s) 1530 includes a touch screen 1532, a microphone 1534, a camera 1536, a physical keyboard 1538, and a trackball 1540. Not all components of computing device 1502 shown in FIG. 15 are present in all embodiments, additional components not shown may be present, and any combination of the components may be present in a particular embodiment. These components of computing device 1502 are described as follows.

A single processor 1510 (e.g., central processing unit (CPU), microcontroller, a microprocessor, signal processor, ASIC (application specific integrated circuit), and/or other physical hardware processor circuit) or multiple processors 1510 may be present in computing device 1502 for performing such tasks as program execution, signal coding, data processing, input/output processing, power control, and/or other functions. Processor 1510 may be a single-core or multi-core processor, and each processor core may be single-threaded or multithreaded (to provide multiple threads of execution concurrently). Processor 1510 is configured to execute program code stored in a computer readable medium, such as program code of operating system 1512 and application programs 1514 stored in storage 1520. Operating system 1512 controls the allocation and usage of the components of computing device 1502 and provides support for one or more application programs 1514 (also referred to as “applications” or “apps”). Application programs 1514 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein.

Any component in computing device 1502 can communicate with any other component according to function, although not all connections are shown for ease of illustration. For instance, as shown in FIG. 15, bus 1506 is a multiple signal line communication medium (e.g., conductive traces in silicon, metal traces along a motherboard, wires, etc.) that may be present to communicatively couple processor 1510 to various other components of computing device 1502, although in other embodiments, an alternative bus, further buses, and/or one or more individual signal lines may be present to communicatively couple components. Bus 1506 represents one or more of any of several types of bus structures, including a memory bus or memory controller, a peripheral bus, an accelerated graphics port, and a processor or local bus using any of a variety of bus architectures.

Storage 1520 is physical storage that includes one or both of memory 1556 and storage device 1590, which store operating system 1512, application programs 1514, and application data 1516 according to any distribution. Non-removable memory 1522 includes one or more of RAM (random access memory), ROM (read only memory), flash memory, a solid-state drive (SSD), a hard disk drive (e.g., a disk drive for reading from and writing to a hard disk), and/or other physical memory device type. Non-removable memory 1522 may include main memory and may be separate from or fabricated in a same integrated circuit as processor 1510. As shown in FIG. 15, non-removable memory 1522 stores firmware 1518, which may be present to provide low-level control of hardware. Examples of firmware 1518 include BIOS (Basic Input/Output System, such as on personal computers) and boot firmware (e.g., on smart phones). Removable memory 1524 may be inserted into a receptacle of or otherwise coupled to computing device 1502 and can be removed by a user from computing device 1502. Removable memory 1524 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 1590 may be present that are internal and/or external to a housing of computing device 1502 and may or may not be removable. Examples of storage device 1590 include a hard disk drive, a SSD, a thumb drive (e.g., a USB (Universal Serial Bus) flash drive), or other physical storage device.

One or more programs may be stored in storage 1520. Such programs include operating system 1512, one or more application programs 1514, and other program modules and program data. Examples of such application programs may include, for example, computer program logic (e.g., computer program code/instructions) for implementing one or more of application 110, VM instance 116A, VM instance 116n, vTPM 118A, vTPM 118n, provisioning service 122, seed value generation service 124, measurement device 210, hardware seed value generator 212, virtual machine manager 214, VM instance 216, guest firmware 218, firmware initializer 220, vTPM 222, guest boot manager 224, VM operating system 234, rebooted vTPM 716, and/or application 902, along with any components and/or subcomponents thereof, as well as the flowcharts/flow diagrams (e.g., flowcharts 300, 400A, 400B, 400C, 400D, 500, 600, 800, 1000, 1100, 1200, 1300, and/or 1400) described herein, including portions thereof, and/or further examples described herein.

Storage 1520 also stores data used and/or generated by operating system 1512 and application programs 1514 as application data 1516. Examples of application data 1516 include web pages, text, images, tables, sound files, video data, and other data, which may also be sent to and/or received from one or more network servers or other devices via one or more wired or wireless networks. Storage 1520 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 1502 through one or more input devices 1530 and may receive information from computing device 1502 through one or more output devices 1550. Input device(s) 1530 may include one or more of touch screen 1532, microphone 1534, camera 1536, physical keyboard 1538 and/or trackball 1540 and output device(s) 1550 may include one or more of speaker 1552 and display 1554. Each of input device(s) 1530 and output device(s) 1550 may be integral to computing device 1502 (e.g., built into a housing of computing device 1502) or external to computing device 1502 (e.g., communicatively coupled wired or wirelessly to computing device 1502 via wired interface(s) 1580 and/or wireless modem(s) 1560). Further input devices 1530 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 1554 may display information, as well as operating as touch screen 1532 by receiving user commands and/or other information (e.g., by touch, finger gestures, virtual keyboard, etc.) as a user interface. Any number of each type of input device(s) 1530 and output device(s) 1550 may be present, including multiple microphones 1534, multiple cameras 1536, multiple speakers 1552, and/or multiple displays 1554.

One or more wireless modems 1560 can be coupled to antenna(s) (not shown) of computing device 1502 and can support two-way communications between processor 1510 and devices external to computing device 1502 through network 1504, as would be understood to persons skilled in the relevant art(s). Wireless modem 1560 is shown generically and can include a cellular modem 1566 for communicating with one or more cellular networks, such as a GSM network for data and voice communications within a single cellular network, between cellular networks, or between the mobile device and a public switched telephone network (PSTN). Wireless modem 1560 may also or alternatively include other radio-based modem types, such as a Bluetooth modem 1564 (also referred to as a “Bluetooth device”) and/or Wi-Fi 1562 modem (also referred to as an “wireless adaptor”). Wi-Fi modem 1562 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 1564 is configured to communicate with another Bluetooth-capable device according to the Bluetooth short-range wireless technology standard(s) such as IEEE 802.15.1 and/or managed by the Bluetooth Special Interest Group (SIG).

Computing device 1502 can further include power supply 1582, LI receiver 1584, accelerometer 1586, and/or one or more wired interfaces 1580. Example wired interfaces 1580 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, an Ethernet port, and/or an Apple® Lightning® port, the purposes and functions of each of which are well known to persons skilled in the relevant art(s). Wired interface(s) 1580 of computing device 1502 provide for wired connections between computing device 1502 and network 1504, or between computing device 1502 and one or more devices/peripherals when such devices/peripherals are external to computing device 1502 (e.g., a pointing device, display 1554, speaker 1552, camera 1536, physical keyboard 1538, etc.). Power supply 1582 is configured to supply power to each of the components of computing device 1502 and may receive power from a battery internal to computing device 1502, and/or from a power cord plugged into a power port of computing device 1502 (e.g., a USB port, an A/C power port). LI receiver 1584 may be used for location determination of computing device 1502 and may include a satellite navigation receiver such as a Global Positioning System (GPS) receiver or may include other type of location determiner configured to determine location of computing device 1502 based on received information (e.g., using cell tower triangulation, etc.). Accelerometer 1586 may be present to determine an orientation of computing device 1502.

Note that the illustrated components of computing device 1502 are not required or all-inclusive, and fewer or greater numbers of components may be present as would be recognized by one skilled in the art. For example, computing device 1502 may also include one or more of a gyroscope, barometer, proximity sensor, ambient light sensor, digital compass, etc. Processor 1510 and memory 1556 may be co-located in a same semiconductor device package, such as being included together in an integrated circuit chip, FPGA, or system-on-chip (SOC), optionally along with further components of computing device 1502.

In embodiments, computing device 1502 is configured to implement any of the above-described features of flowcharts herein. Computer program logic for performing any of the operations, steps, and/or functions described herein may be stored in storage 1520 and executed by processor 1510.

In some embodiments, server infrastructure 1570 may be present in computing environment 1500 and may be communicatively coupled with computing device 1502 via network 1504. Server infrastructure 1570, when present, may be a network-accessible server set (e.g., a cloud computing platform). As shown in FIG. 15, server infrastructure 1570 includes clusters 1572. Each of clusters 1572 may comprise a group of one or more compute nodes and/or a group of one or more storage nodes. For example, as shown in FIG. 15, cluster 1572 includes nodes 1574. Each of nodes 1574 are accessible via network 1504 (e.g., in a “cloud computing platform” or “cloud-based” embodiment) to build, deploy, and manage applications and services. Any of nodes 1574 may be a storage node that comprises a plurality of physical storage disks, SSDs, and/or other physical storage devices that are accessible via network 1504 and are configured to store data associated with the applications and services managed by nodes 1574. For example, as shown in FIG. 15, nodes 1574 may store application data 1578.

Each of nodes 1574 may, as a compute node, comprise one or more server computers, server systems, and/or computing devices. For instance, a node 1574 may include one or more of the components of computing device 1502 disclosed herein. Each of nodes 1574 may be configured to execute one or more software applications (or “applications”) and/or services and/or manage hardware resources (e.g., processors, memory, etc.), which may be utilized by users (e.g., customers) of the network-accessible server set. For example, as shown in FIG. 15, nodes 1574 may operate application programs 1576. In an implementation, a node of nodes 1574 may operate or comprise one or more virtual machines, with each virtual machine emulating a system architecture (e.g., an operating system), in an isolated manner, upon which applications such as application programs 1576 may be executed.

In an embodiment, one or more of clusters 1572 may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 1572 may be a datacenter in a distributed collection of datacenters. In embodiments, exemplary computing environment 1500 comprises part of a cloud-based platform such as Amazon Web Services® of Amazon Web Services, Inc., or Google Cloud Platform™ of Google LLC, although these are only examples and are not intended to be limiting.

In an embodiment, computing device 1502 may access application programs 1576 for execution in any manner, such as by a client application and/or a browser at computing device 1502. Example browsers include Microsoft Edge® by Microsoft Corp. of Redmond, Washington, Mozilla Firefox®, by Mozilla Corp. of Mountain View, California, Safari®, by Apple Inc. of Cupertino, California, and Google® Chrome by Google LLC of Mountain View, California.

For purposes of network (e.g., cloud) backup and data security, computing device 1502 may additionally and/or alternatively synchronize copies of application programs 1514 and/or application data 1516 to be stored at network-based server infrastructure 1570 as application programs 1576 and/or application data 1578. For instance, operating system 1512 and/or application programs 1514 may include a file hosting service client, such as Microsoft® OneDrive® by Microsoft Corporation, Amazon Simple Storage Service (Amazon S3)® by Amazon Web Services, Inc., Dropbox® by Dropbox, Inc., Google Drive™ by Google LLC, etc., configured to synchronize applications and/or data stored in storage 1520 at network-based server infrastructure 1570.

In some embodiments, on-premises servers 1592 may be present in computing environment 1500 and may be communicatively coupled with computing device 1502 via network 1504. On-premises servers 1592, when present, are hosted within an organization's infrastructure and, in many cases, physically onsite of a facility of that organization. On-premises servers 1592 are controlled, administered, and maintained by IT (Information Technology) personnel of the organization or an IT partner to the organization. Application data 1598 may be shared by on-premises servers 1592 between computing devices of the organization, including computing device 1502 (when part of an organization) through a local network of the organization, and/or through further networks accessible to the organization (including the Internet). Furthermore, on-premises servers 1592 may serve applications such as application programs 1596 to the computing devices of the organization, including computing device 1502. Accordingly, on-premises servers 1592 may include storage 1594 (which includes one or more physical storage devices such as storage disks and/or SSDs) for storage of application programs 1596 and application data 1598 and may include one or more processors for execution of application programs 1596. Still further, computing device 1502 may be configured to synchronize copies of application programs 1514 and/or application data 1516 for backup storage at on-premises servers 1592 as application programs 1596 and/or application data 1598.

Embodiments described herein may be implemented in one or more of computing device 1502, network-based server infrastructure 1570, and on-premises servers 1592. For example, in some embodiments, computing device 1502 may be used to implement systems, clients, or devices, or components/subcomponents thereof, disclosed elsewhere herein. In other embodiments, a combination of computing device 1502, network-based server infrastructure 1570, and/or on-premises servers 1592 may be used to implement the systems, clients, or devices, or components/subcomponents thereof, disclosed elsewhere herein.

As used herein, the terms “computer program medium,” “computer-readable medium,” and “computer-readable storage medium,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 1520. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 1514) may be stored in storage 1520. Such computer programs may also be received via wired interface(s) 1580 and/or wireless modem(s) 1560 over network 1504. Such computer programs, when executed or loaded by an application, enable computing device 1502 to implement features of embodiments discussed herein. Accordingly, such computer programs represent controllers of the computing device 1502.

Embodiments are also directed to computer program products comprising computer code or instructions stored on any computer-readable medium or computer-readable storage medium. Such computer program products include the physical storage of storage 1520 as well as further physical storage types.

### V. Additional Exemplary Embodiments

A system is described herein. The system comprises a processor and memory. The memory comprises program code executable by the processor. The program code comprises an instance of a virtual machine and a virtual trusted platform module (TPM). The vTPM is configured to: receive a first seed value representative of a system feature of the system; generate a first key from the first seed value, the first key configured to unseal a sealed state of an operating system of the virtual machine; utilize the first key to unseal the sealed state of the operating system; and provide the unsealed state to the instance of the virtual machine to cause the instance of the virtual machine to boot the operating system based on the unsealed state.

In an implementation of the foregoing system, to receive the first seed value, the vTPM is further configured to receive the first seed value from a secured portion of the memory.

In an implementation of the foregoing system, to receive the first seed value, the vTPM is further configured to: transmit, to a host service of the system, a request for the first seed value; and receive, from the host service, the first seed value.

In an implementation of the foregoing system, the system feature is a configuration of the instance of the virtual machine, and to receive the first seed value, the vTPM is further configured to: transmit, to a server of a cloud service platform associated with the virtual machine, a request for the first seed value; and receive, from the server, the first seed value.

In an implementation of the foregoing system, the vTPM is further configured to: receive a second seed value representative of another system feature; and generate the first key from the first seed value and the second seed value.

In an implementation of the foregoing system, subsequent to the vTPM rebooting, the vTPM is further configured to: receive a second seed value representative of the system feature; and determine the second seed value does not meet criterion for unsealing the sealed state of the operating system.

In an implementation of the foregoing system, to determine the second seed value does not meet the criterion, the vTPM is further configured to: generate a second key from the second seed value; and determine the second key is unable to unseal the sealed state of the operating system.

In an implementation of the foregoing system, the system feature comprises at least one of: a hardware configuration of the system; a geographic region to which the vTPM is assigned; a tenant of a cloud service to which the vTPM is assigned; the instance of the virtual machine; the operating system of the virtual machine; or a firmware disk of the virtual machine.

In an implementation of the foregoing system, the instance of the virtual machine comprises the vTPM.

In an implementation of the foregoing system, the vTPM is further configured to: determine a cryptographic operation is to be performed; determine whether a lifetime of a key configured for use in performing the cryptographic operation has expired; if the lifetime of the key has not expired, attempt to perform the cryptographic operation; and if the lifetime of the key has expired, fail to perform the cryptographic operation.

A method is described herein. The method is performed by a vTPM executing on a computing device of a system. The computing device is configured to host an instance of a virtual machine. The method comprises: receiving a first seed value representative of a system feature of the system; generating a first key from the first seed value, the first key configured to unseal a sealed state of an operating system of the virtual machine; utilizing the first key to unseal the sealed state of the operating system; and providing the unsealed state to the instance of the virtual machine to cause the instance of the virtual machine to boot the operating system based on the unsealed state.

In an implementation of the foregoing method, said receiving the first seed value comprises receiving the first seed value from a secured portion of memory of the computing device.

In an implementation of the foregoing method, said receiving the first seed value comprises: transmitting, to a host service or a hardware component of the system, a request for the first seed value; and receiving, from the host service or the hardware component, the first seed value.

In an implementation of the foregoing method, said receiving the first seed value comprises: transmitting, to a server of a cloud service platform associated with the virtual machine, a request for the first seed value; and receiving, from the server, the first seed value.

In an implementation of the foregoing method, the method further comprises: receiving a second seed value representative of another system feature; and generating the first key from the first seed value and the second seed value.

In an implementation of the foregoing method, the method further comprises: subsequent to the vTPM rebooting, receiving a second seed value representative of the system feature, and determining the second seed value does not meet criterion for unsealing the sealed state of the operating system.

In an implementation of the foregoing method, said determining the second seed value does not meet the criterion comprises: generating a second key from the second seed value; and determining the second key is unable to unseal the sealed state of the operating system.

In an implementation of the foregoing method, the system feature comprises at least one of: a hardware configuration of the system; a geographic region to which the vTPM is assigned; a tenant of a cloud service to which the vTPM is assigned; the instance of the virtual machine; the operating system of the virtual machine; or a firmware disk of the virtual machine.

In an implementation of the foregoing method, the method further comprises: receiving, from an application executed by the instance of the virtual machine, a request to perform a cryptographic operation to modify an object by utilizing the first key to: seal the object, unseal the object, sign the object, decrypt the object, or encrypt the object.

In an implementation of the foregoing method, the method further comprises: determining a cryptographic operation is to be performed; determining whether a lifetime of a key configured for use in performing the cryptographic operation has expired; if the lifetime of the key has not expired, attempting to perform the cryptographic operation; and if the lifetime of the key has expired, failing to perform the cryptographic operation.

In an implementation of the foregoing method, the instance of the virtual machine comprises the vTPM.

A computer-readable storage medium is described herein. The computer-readable storage medium is encoded with program instructions that, when executed by a processor circuit of a system configured to host an instance of a virtual machine, performs a method. The method comprises: receiving a first seed value representative of a system feature of the system; generating a first key from the first seed value, the first key configured to unseal a sealed state of an operating system of the virtual machine; utilizing the first key to unseal the sealed state of the operating system; and providing the unsealed state to the instance of the virtual machine to cause the instance of the virtual machine to boot the operating system based on the unsealed state.

In an implementation of the foregoing computer-readable storage medium, said receiving the first seed value comprises receiving the first seed value from a secured portion of memory of the computing device.

In an implementation of the foregoing computer-readable storage medium, said receiving the first seed value comprises: transmitting, to a host service or a hardware component of the system, a request for the first seed value; and receiving, from the host service or the hardware component, the first seed value.

In an implementation of the foregoing computer-readable storage medium, said receiving the first seed value comprises: transmitting, to a server of a cloud service platform associated with the virtual machine, a request for the first seed value; and receiving, from the server, the first seed value.

In an implementation of the foregoing computer-readable storage medium, the method further comprises: receiving a second seed value representative of another system feature; and generating the first key from the first seed value and the second seed value.

In an implementation of the foregoing computer-readable storage medium, the method further comprises: subsequent to the vTPM rebooting, receiving a second seed value representative of the system feature, and determining the second seed value does not meet criterion for unsealing the sealed state of the operating system.

In an implementation of the foregoing computer-readable storage medium, said determining the second seed value does not meet the criterion comprises: generating a second key from the second seed value; and determining the second key is unable to unseal the sealed state of the operating system.

In an implementation of the foregoing computer-readable storage medium, the system feature comprises at least one of: a hardware configuration of the system; a geographic region to which the vTPM is assigned; a tenant of a cloud service to which the vTPM is assigned; the instance of the virtual machine; the operating system of the virtual machine; or a firmware disk of the virtual machine.

In an implementation of the foregoing computer-readable storage medium, the method further comprises: receiving, from an application executed by the instance of the virtual machine, a request to perform a cryptographic operation to modify an object by utilizing the first key to: seal the object, unseal the object, sign the object, decrypt the object, or encrypt the object.

In an implementation of the foregoing computer-readable storage medium, the method further comprises: determining a cryptographic operation is to be performed; determining whether a lifetime of a key configured for use in performing the cryptographic operation has expired; if the lifetime of the key has not expired, attempting to perform the cryptographic operation; and if the lifetime of the key has expired, failing to perform the cryptographic operation.

In an implementation of the foregoing computer-readable storage medium, the instance of the virtual machine comprises the vTPM.

### VI. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives modifying a condition or relationship characteristic of a feature or features of an implementation of the disclosure, should be understood to mean that the condition or characteristic is defined to within tolerances that are acceptable for operation of the implementation for an application for which it is intended. Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

Numerous example embodiments have been described above. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Furthermore, example embodiments have been described above with respect to one or more running examples. Such running examples describe one or more particular implementations of the example embodiments; however, embodiments described herein are not limited to these particular implementations.

Further still, several example embodiments have been described with respect to vTPMs deployed in a VM instance. However, it is also contemplated herein that a vTPM may be implemented as a service executing on the same host computing device as a VM instance, or as a service executing on a computing device coupled to the host computing device. Furthermore, example embodiments have been described with respect to VM instances and vTPMs implemented as services (or subservices) deployed on a host computing device of a server infrastructure (e.g., of a cloud service in a cloud computing implementation); however, embodiments of vTPMs and VM instances may also be implemented as service(s) deployed on an end-user's computing device (e.g., in an edge computing implementation), as a service deployed on an organization's computing device (e.g., in an on-premise computing implementation), and/or the like.

Moreover, according to the described embodiments and techniques, any components of systems, computing devices, service provider systems, host computing devices, vTPMs, VM instances, and/or processing systems and their functions may be caused to be activated for operation/performance thereof based on other operations, functions, actions, and/or the like, including initialization, completion, and/or performance of the operations, functions, actions, and/or the like.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (or completely) concurrently with each other or with other operations.

The embodiments described herein and/or any further systems, sub-systems, devices and/or components disclosed herein may be implemented in hardware (e.g., hardware logic/electrical circuitry), or any combination of hardware with software (computer program code configured to be executed in one or more processors or processing devices) and/or firmware.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

What is claimed is:

1. A system comprising:
a processor;
memory comprising program code executable by the processor, the program code comprising an instance of a virtual machine and a virtual trusted platform module (vTPM), the vTPM configured to:
receive a first seed value representative of a system feature of the system;
generate a first key from the first seed value, the first key configured to unseal a sealed state of an operating system of the virtual machine;
utilize the first key to unseal the sealed state of the operating system; and
provide the unsealed state to the instance of the virtual machine to cause the instance of the virtual machine to boot the operating system based on the unsealed state.

2. The system of claim 1, wherein to receive the first seed value, the vTPM is further configured to receive the first seed value from a secured portion of the memory.

3. The system of claim 1, wherein to receive the first seed value, the vTPM is further configured to:
transmit, to a host service of the system, a request for the first seed value; and
receive, from the host service, the first seed value.

4. The system of claim 1, wherein the system feature is a configuration of the instance of the virtual machine, and to receive the first seed value, the vTPM is further configured to:
transmit, to a server of a cloud service platform associated with the virtual machine, a request for the first seed value; and
receive, from the server, the first seed value.

5. The system of claim 1, wherein the vTPM is further configured to:
receive a second seed value representative of another system feature; and
generate the first key from the first seed value and the second seed value.

6. The system of claim 1, wherein, subsequent to the vTPM rebooting, the vTPM is further configured to:
receive a second seed value representative of the system feature;
determine the second seed value does not meet criterion for unsealing the sealed state of the operating system.

7. The system of claim 6, wherein to determine the second seed value does not meet the criterion, the vTPM is further configured to:
generate a second key from the second seed value;
determine the second key is unable to unseal the sealed state of the operating system.

8. The system of claim 1, wherein the system feature comprises at least one of:
a hardware configuration of the system;
a geographic region to which the vTPM is assigned;
a tenant of a cloud service to which the vTPM is assigned;
the instance of the virtual machine;
the operating system of the virtual machine; or
a firmware disk of the virtual machine.

9. The system of claim 1, wherein the instance of the virtual machine comprises the vTPM.

10. A method performed by a vTPM executing on a computing device of a system, the computing device configured to host an instance of a virtual machine, the method comprising:
receiving a first seed value representative of a system feature of the system;
generating a first key from the first seed value, the first key configured to unseal a sealed state of an operating system of the virtual machine;
utilizing the first key to unseal the sealed state of the operating system; and
providing the unsealed state to the instance of the virtual machine to cause the instance of the virtual machine to boot the operating system based on the unsealed state.

11. The method of claim 10, wherein said receiving the first seed value comprises receiving the first seed value from a secured portion of memory of the computing device.

12. The method of claim 10, wherein said receiving the first seed value comprises:
transmitting, to a host service or a hardware component of the system, a request for the first seed value; and
receiving, from the host service or the hardware component, the first seed value.

13. The method of claim 10, wherein said receiving the first seed value comprises:
transmitting, to a server of a cloud service platform associated with the virtual machine, a request for the first seed value; and
receiving, from the server, the first seed value.

14. The method of claim 10, further comprising:
receiving a second seed value representative of another system feature; and
generating the first key from the first seed value and the second seed value.

15. The method of claim 10, wherein the method further comprises:
subsequent to the vTPM rebooting,
receiving a second seed value representative of the system feature, and
determining the second seed value does not meet criterion for unsealing the sealed state of the operating system.

16. The method of claim 15, wherein said determining the second seed value does not meet the criterion comprises:
generating a second key from the second seed value; and
determining the second key is unable to unseal the sealed state of the operating system.

17. The method of claim 10, wherein the system feature comprises at least one of:
a hardware configuration of the system;
a geographic region to which the vTPM is assigned;
a tenant of a cloud service to which the vTPM is assigned;
the instance of the virtual machine;
the operating system of the virtual machine; or
a firmware disk of the virtual machine.

18. The method of claim 10, further comprising:
receiving, from an application executed by the instance of the virtual machine, a request to perform a cryptographic operation to modify an object by utilizing the first key to:
seal the object,
unseal the object,
sign the object,
verify the object,
decrypt the object, or
encrypt the object.

19. The method of claim 10, further comprising:
determining a cryptographic operation is to be performed;
determining whether a lifetime of the first key has expired;
if the lifetime of the first key has not expired, attempting to utilize the first key to perform the cryptographic operation; and
if the lifetime of the first key has expired, failing to perform the cryptographic operation.

20. A computer-readable storage medium encoded with program instructions that, when executed by a processor circuit of a system configured to host an instance of a virtual machine, performs a method comprising:
receiving a first seed value representative of a system feature of the system;
generating a first key from the first seed value, the first key configured to unseal a scaled state of an operating system of the virtual machine;
utilizing the first key to unseal the scaled state of the operating system; and
providing the unsealed state to the instance of the virtual machine to cause the instance of the virtual machine to boot the operating system based on the unsealed state.
